(19) United States
(12) Patent Application Publication
(10) Pub. No.: US 2017/0024682 A1
(43) Pub. Date: Jan. 26, 2017

(54) REMOTE TRAVEL SERVICE

(71) Applicant: GREGORY A. PICCIONELLI, WESTLAKE VILLAGE, CA (US)

(72) Inventor: GREGORY A. PICCIONELLI, WESTLAKE VILLAGE, CA (US)

(73) Assignee: GREGORY PICCIONELLI, WESTLAKE VILLAGE, CA (US)

(21) Appl. No.: 15/188,920

(22) Filed: Jun. 21, 2016

Related U.S. Application Data
(63) Continuation of application No. 13/624,401, filed on Sep. 21, 2012.
Application No. 13/624,401 is a continuation of application No. 13/815,742, filed on Mar. 15, 2013, now abandoned.
Application No. 13/815,742 is a continuation-in-part of application No. 13/624,401, filed on Sep. 21, 2012.
Application No. 13/815,742 is a continuation-in-part of application No. 09/812,296, filed on Mar. 20, 2001.
Application No. 09/812,296 is a continuation-in-part of application No. 13/317,622, filed on Oct. 24, 2011.
Application No. 13/317,622 is a continuation-in-part of application No. 12/070,715, filed on Feb. 20, 2008, now abandoned.
Application No. 12/070,715 is a continuation-in-part of application No. 11/998,679, filed on Nov. 30, 2007, now abandoned.
Application No. 11/998,679 is a continuation of application No. 10/460,105, filed on Jun. 11, 2003, now abandoned.
Application No. 10/460,105 is a continuation of application No. 13/815,765, filed on Mar. 15, 2013.
Application No. 13/815,765 is a continuation-in-part of application No. 13/317,622, filed on Oct. 24, 2011.
Application No. 13/317,622 is a continuation-in-part of application No. 11/998,679, filed on Nov. 30, 2007, now abandoned.
Application No. 11/998,679 is a continuation of application No. 10/460,105, filed on Jun. 11, 2003, now abandoned.
Application No. 13/317,622 is a continuation-in-part of application No. 12/070,715, filed on Feb. 20, 2008, now abandoned.
Application No. 13/815,765 is a continuation-in-part of application No. 09/812,296, filed on Mar. 20, 2001.
Application No. 09/812,296 is a continuation of application No. 13/644,094, filed on Oct. 3, 2012.
(60) Provisional application No. 61/626,343, filed on Sep. 22, 2011.
(60) Provisional application No. 61/626,787, filed on Oct. 3, 2011.
(60) Provisional application No. 61/626,787, filed on Oct. 3, 2011.
(60) Provisional application No. 61/626,343, filed on Sep. 22, 2011.
(60) Provisional application No. 60/191,003, filed on Mar. 21, 2000.
(60) Provisional application No. 60/902,771, filed on Feb. 21, 2007.
(60) Provisional application No. 60/388,381, filed on Jun. 12, 2002.
(60) Provisional application No. 60/388,381, filed on Jun. 12, 2002.
(60) Provisional application No. 60/902,771, filed on Feb. 21, 2007.
(60) Provisional application No. 60/191,003, filed on Mar. 21, 2000.
(60) Provisional application No. 61/626,788, filed on Oct. 3, 2011.

(51) Int. Cl. G06Q 10/06; H04N 7/14; H04W 4/02

(52) U.S. Cl. CPC G06Q 10/063114; H04W 4/023; H04N 7/141; G06Q 30/0259

(57) ABSTRACT

A client requests for an agent to provide a service from a server, where the server response with a list of agents based upon the location of the agent relative to the client.

### CROSS REFERENCE TO RELATED APPLICATIONS

This application claims priority to U.S. patent application Ser. No. 13/624,401, titled TELEPRESENCE SYSTEM FOR PROVIDING INFORMATION TO A USER THROUGH AN AGENT BASED ON THE LOCATION OF THE AGENT, filed Sep. 21, 2012, that claims priority under 35 U.S.C. §119(e), to both U.S. Provisional Patent Application Ser. No. 61/626,343, titled “SYSTEM AND PROCESS FOR PROVIDING INFORMATION, SUCH AS ADVERTISING, BY ONE OR MORE INFORMATION PROVIDERS TO ONE OR MORE RECIPIENTS BASED ON THE LOCATION OF ONE OR MORE THIRD PARTIES,” filed Sep. 22, 2011, and U.S. Provisional Patent Application Ser. No. 61/626,787, titled “SYSTEM AND PROCESS FOR PROVIDING INFORMATION, SUCH AS ADVERTISING, BY ONE OR MORE INFORMATION PROVIDERS TO ONE OR MORE RECIPIENTS BASED ON THE LOCATION OF ONE OR MORE THIRD PARTIES,” filed Oct. 3, 2011, both of which are herein incorporated by reference in their entirety.

This application claims priority to U.S. patent application Ser. No. 13/815,742, titled TELEPRESENCE SYSTEM FOR PROVIDING INFORMATION TO A USER THROUGH AN AGENT BASED ON THE LOCATION OF THE AGENT, filed on Mar. 15, 2013, that claims priority as a continuation-in-part of application Ser. No. 13/624,401, filed on Sep. 21, 2012, continuation-in-part of application Ser. No. 09/812,296, filed on Mar. 20, 2001 and Provisional Application Ser. No. 61/626,343, filed on Sep. 22, 2011, provisional application No. 61/626,787, filed on Oct. 3,2011, Provisional Application Ser. No. 60/191,003, filed on Mar. 21, 2000, all of which are herein incorporated by reference in their entirety.

This application is a continuation-in-part of U.S. patent application Ser. No. 13/317,622, filed Oct. 24, 2011, which in turn is a continuation-in-part of U.S. patent application Ser. No. 11/998,679, filed Nov. 30, 2007, which in turn is a continuation of U.S. patent application Ser. No. 10/460,105, filed Jun. 11, 2003, which in turn is based on U.S. Provisional Patent Application Ser. No. 60/388,381, filed Jun. 12, 2002, and also a continuation-in-part of U.S. patent application Ser. No. 12/070,715, in the name of Gregory A. Piccionelli and Michael M. Gerardi, entitled “CO-ORDINATED ON-LINE VIDEO VIEWING”, filed Feb. 20, 2008, which in turn is based on U.S. Provisional Patent Application Ser. No. 60/902,771, filed Feb. 21, 2007. This application is also a continuation-in-part of U.S. patent application Ser. No. 09/812,296, filed Mar. 20, 2001, which in turn was based on U.S. Provisional Patent Application Ser. No. 60/191,003, filed Mar. 21, 2000, all of which are incorporated by reference in their entirety.

This application claims priority to application Ser. No. 13/815,765, filed on Mar. 15, 2013, titled REMOTE DATING METHOD, which was a continuation-in-part of application Ser. No. 13/317,622,filed on Oct. 24, 2011, Which is a continuation-in-part of application Ser. No. 11/998,679, Filed on Nov. 30, 2007,now abandoned, Which is a continuation of application Ser. No. 10/460,105, filed on Jun. 11, 2003, now abandoned, said application Ser. No. 13/317,622 is a continuation-in-part of application Ser. No. 12/070,715, Filed on Feb. 20, 2008, now abandoned, Continuation-in-part of application Ser. No. 09/812,296, Filed on Mar. 20, 2001. Provisional application No. 60/388,381, Filed on Jun. 12, 2002, provisional application No. 60/902,771, Filed on Feb. 21, 2007, provisional application No. 60/191,003, Filed on Mar. 21, 2000, all of which are incorporated by reference in their entirety.

This application claims priority to U.S. patent application Ser. No. 13,644,094, titled “METHODS AND SYSTEMS FOR FACILITATING IN-PERSON INTERACTION BETWEEN MMVE USERS WHOSE AVATARS HAVE INTERACTED VIRTUALLY,” filed on Oct. 3, 2012, which claims priority under 35 U.S.C. §119(e), to U.S. Provisional Patent Application Ser. No. 61/626,788, titled “METHODS AND SYSTEMS FOR FACILITATING IN-PERSON INTERACTION BETWEEN MMVE USERS WHOSE AVATARS HAVE INTERACTED VIRTUALLY,” filed Oct. 3, 2011, which are herein incorporated by reference in its entirety.

This application claims priority to U.S. patent application, Ser. No. 13/815,795, titled “AGGREGATION OF LIVE PERFORMANCES ON AN AGGREGATE SITE ON A NETWORK,” filed on Mar. 15,2013 and is continuation-in-part of U.S. patent application Ser. No. 13/385,847, filed Mar. 9, 2012, which in turn was based on U.S. Provisional Patent Application Ser. No. 61/464,936, filed Mar. 11, 2011, and is also a continuation-in-part of U.S. patent application Ser. No. 09/812,296, filed Mar. 20, 2001, which in turn was based on U.S. Provisional Patent Application Ser. No. 60/191,003, filed Mar. 21, 2000, the entire disclosures of each are incorporated herein by reference and each of which priority is claimed.

The disclosures of each of the foregoing patent applications are incorporated in their entirety herein by this reference, and priority is claimed from each of the foregoing patent applications.

### TECHNICAL FIELD

This invention relates generally to communication systems, and in particular telepresence communication systems.

### BACKGROUND

Network communications has become common in modern society. Systems utilizing network communications include, for example, systems that allow network communication on the Internet and cellular networks, wireless communication systems, and telepresence systems that utilize telepresence technologies,

Wireless communication devices have evolved from simple analog radios to modern cellular telephones, personal digital assistants (“PDAs”), smartphones, portable computers, and tablets. As these wireless communication devices continue to evolve, manufactures and software developers are continuously improving the input devices (i.e., microphones, cameras, keyboards, wireless connectivity, such as Bluetooth® and Wi-Fi® technologies) and software applications available to these wireless communication devices. These wireless communication devices allow users to use both cellular communication networks and the Internet for such activities as voice calls, Internet surfing, texting, tweets, mailing, etc.

Additionally, many modern wireless communication devices are also including location determination technologies (“LDT”) circuitry that may include, for example, a global positioning system (“GPS”) module, an aided location communication system, a multilateration module, a Wi-Fi® identification module, or combination of these technologies that allow the determination of a location of specific wireless communication device. An example of an aided location communication system is described in U.S. Pat. No. 7,970,412, titled “AIDED LOCATION COMMUNICATION SYSTEM,” issued on Jun. 28 2011 which is herein incorporated by reference in its entirety.

With the advent of LDT, many wireless services have included mapping d pushing applications that include business information or push advertising to the wireless communication device based on the location of the wireless device. At present, there are numerous technologies that provide for transmission of information from an information provider to a user of wireless communication device based on the location of the wireless communication device.

Similar to wireless communication devices, network communication on the Internet and cellular networks has also evolved from simple text and voice communication to advanced forms of human communication and interaction. Modern Internet online service platforms such as existing social networking services (for example Facebook®, Twitter®, Google+®, etc.) have established a need for online services that facilitate the building of social networks and/or social relations among people who, for example, share interests, ideas, activities, events, backgrounds, or real-life connections. These online service platforms also seem to have an increasing amount of influence on peoples' identity, privacy, social capital, culture, education, and human interaction both real and virtual.

One result of the Internet has been the ability for many Internet users to experience virtual travel, communicate in various forums, obtain news, establish personal relationships online, and purchase and perform other financial transactions without ever leaving their respective locations. For example, people view live webcams of far off locations; read and post on blogs, forums, and websites; read online newspapers and watch online television and news clips; post and communicate on dating online services; buy from online stores; and bank or make payments via online websites.

Turning to telepresence, telepresence technologies have evolved from being mostly government program applications to everyday applications utilized by businesses and normal people. In general, telepresence technologies allow a person to feel as if they were present, to give the appearance of being present to others, or to have the effect, via telerobotics, at a place other than their true location. One of the most common telepresence technologies is video conferencing that allows two parties to communicate via a two-way video link that gives a somewhat appearance and feel of having both parties physically present in the same location. Technical advances in mobile wireless devices has enabled many handheld mobile devices, such as, for example, iPhones®, iPad®, Android® based mobile devices, and Microsoft® based mobile devices to video conference in a way that allows collaboration between users that is independent of the users' individual locations.

Tele-robotics is a telepresence technology that is an area of robotics concerned with the control of robots from a distance chiefly using wireless connections, tethered connections, or the Internet. Examples of the wireless connections includes, for example, Wi-Fi®, Bluetooth®, and the Deep Space Network used by government space agencies such as NASA. In general, tele-robotics is a combination of teleoperation and telepresence where teleoperation means doing work at a distance. Within tele-robotics, a tele-manipulator (or tele-operator) is a device that is controlled remotely by a human operator.

Telepresence technologies are developed whereby a party controls another party remotely to provide to the user party the ability to remotely shop and engage in other activities, a need exists to provide information to the user, not on the basis of the user's location, but on the basis of the location of the user's agent who is in a remote location.

In modern society, in particular in large urban areas, it is often difficult for individuals to make social contacts with other individuals of interest. Organized activities such as service organizations, church groups and the like are not always available to all individuals or in many areas. Traditional venues for social interaction, such as bars, nightclubs and the like, often prove unsatisfactory, as do conventional dating services.

Recent developments in telecommunications and data processing, and in particular the development of broadband capability in connection with wide-area networks such as the Internet, offer the potential for facilitating the transmission and reception of large amounts of information between individuals who may be interested in meeting each other. However, at present such interactions are typically confined to inquiring individuals operating from fixed locations, such as home or office computers.

A need exists for a method of enabling individuals to make social and business contacts with each other and agents to provide services such as transportation is needed. More specifically, a need exists for a method enabling individuals in different settings, such as nightclubs, bars, restaurants and the like, to transmit and receive information concerning each other in order to assist in deciding whether to proceed with personal contact, and to facilitate establishment of personal contact. Further, a need exists for a method and approach enabling individuals indifferent settings to transmit and receive information regarding agents that provide services.

### SUMMARY

An approach is provided that enables a user via an online device to request an agent to provide a service. A server selects the agent based upon the location of the agent and characteristics that are desired by the user and/or feedback provided by other users.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a system diagram of an example of an implementation of a telepresence system, in accordance with the invention, for providing information to a user through an agent based on the location of the agent, which is remote to the location of the user.

FIG. 2 is an exemplary block diagram 200 of an online device 109 with a controller 204 in accordance with an example implementation of FIG. 1.

FIG. 3 is an exemplary block diagram 300 of server 136 with a controller in accordance with an example implementation of FIG. 1.

FIG. 4 is a remote travel service in accordance with and example implementation of FIGS. 1-3.

FIG. 5 is a system block diagram of the example of the implementation of the telepresence system, shown in FIG. 1, including a client module and an agent module, in accordance with the invention.

FIG. 6 shows a perspective view of the respective locations of the agent and a registered target are shown in relation to a pre-determined positive location area in accordance with the invention.

FIG. 7 shows a system view of an example of a video transmission from an agent to an online device of a user utilizing the telepresence system as shown in FIG. 1.

FIG. 8 shows a system view of an example of a video transmission from an agent and service provider to an online device of a user when the agent enters into a pre-determined positive location area utilizing the telepresence system as shown in FIG. 1.

FIG. 9 shows a perspective view of the respective locations of the agent and a registered target are shown in relation to a pre-determined negative location in accordance with the invention.

FIG. 10 is a flowchart of an example of an implementation of a process performed by a picture-to-logo converter, in accordance with the present invention.

FIG. 11 is a flowchart illustrating an example of a method of the invention by which an inquiring individual identifies, locates and establishes contact with a target individual,

FIGS. 12A-C are a schematic diagram, side view and top view, respectively, illustrating an exemplary system for implementing a method of the invention, including a headset and an integrated processing/transceiving unit,

FIG. 13 is a top view of an alternative headset that employs an infrared pointer device,

FIG. 14 is an illustration of implementation of a method according to the invention in which an inquiring individual attempts to establish contact with a target individual,

FIG. 15 is an illustration of a display of information pertaining to a target individual, which is provided to an inquiring individual, and

FIG. 16 is a flowchart illustrating a coordinated on-line viewing method used in particular embodiments of methods according to the invention in which an inquiring individual and a target individual agree to watch an on-line video file together.

FIG. 17 is a system diagram of an example of an implementation of system for facilitating in-person interaction between MMVE users in accordance with the invention.

FIG. 18 is a screen shot of an example of an implementation of a scene including two avatars generated by the system shown in FIG. 17 in accordance with the invention.

FIG. 19 is a screen shot of an example of an implementation of a scene including a first user avatar generated by the system shown in FIG. 17 in accordance with the invention.

FIG. 20 is a screen shot of an example of an implementation of a scene including a second user avatar generated by the system shown in FIG. 17 in accordance with the invention.

FIG. 21 is a screen shot of an example of an implementation of a scene including a first user avatar and a second user avatar generated by the system shown in FIG. 17 in accordance with the invention.

FIG. 22 is a system diagram of an example of an implementation of the system shown in FIG. 18 in accordance with the invention.

FIG. 23 is a flowchart of an example of an implementation of a method performed by the system shown in FIG. 22 in accordance with the invention.

FIG. 24A-C are illustrations of a monitoring site that monitors one or more live performance sites (as shown, two sites) that feature live performances by human performers, and an aggregate site that displays only such performances as satisfy a performance criterion. FIG. 24A illustrates an initial state of a display at time T1 in Which thumbnails, numbers, symbols or other abstract indicia associated With various performers are presented for determination of compliance With a performance criterion. FIG. 24B illustrates a subsequent state at time T2 in Which compliant performances are identified. FIG. 24C illustrates the aggregation of compliant performances into the aggregate site, Where each com plaint performance is made available for viewing by a user over a network.

FIGS. 25A-C are illustrations of a subsequent selection procedure in which one or more performances compliant at time T2 (FIG. 25A) become non-compliant at time T3, While other previously non-compliant performances become com pliant (FIG. 25B). Non-compliant performances are then removed from the aggregate site, While the newly-compliant performances are added to the aggregate site (FIG. 25C).

FIG. 26 is a generalized schematic view of a wide area network system, which may be used to implement embodiments of the present invention.

FIG. 27 is a generalized schematic view of a system according to an embodiment of the present invention.

FIG. 28 is a flow chart representing a process carried out by the system of FIG. 26, according to an embodiment of the present invention.

FIG. 29a is a block diagram representing a communication packet provided by a user computer of the system shown in FIG. 26, according to an embodiment of the present invention.

FIG. 29b is a block diagram representing communication packets provided by a user computer and the provider computer of the system shown in FIG. 26, according to a further embodiment of the present invention.

FIG. 30 is a flow chart representing an example embodiment of a process carried out by a user computer of the system shown in FIG. 26.

FIG. 31 is a flow chart representing an example embodiment of a process carried out by the provider computer of the system shown in FIG. 26.

FIG. 32 is a generalized block diagram of a decryption module system.

FIG. 33 is a flow chart representing another example embodiment of a process carried out by a user computer.

FIG. 34 is a flow chart representing another example embodiment of a process carried out by a provider computer.

FIG. 35 is a generalized representation of a shopping area which employs a system according to an embodiment of the present invention.

FIG. 36 is a generalized block diagram of a system for associating content and recipient information in a memory.

FIG. 37 is a generalized block diagram of a system for associating image information with location information.

### DETAILED DESCRIPTION OF THE INVENTION

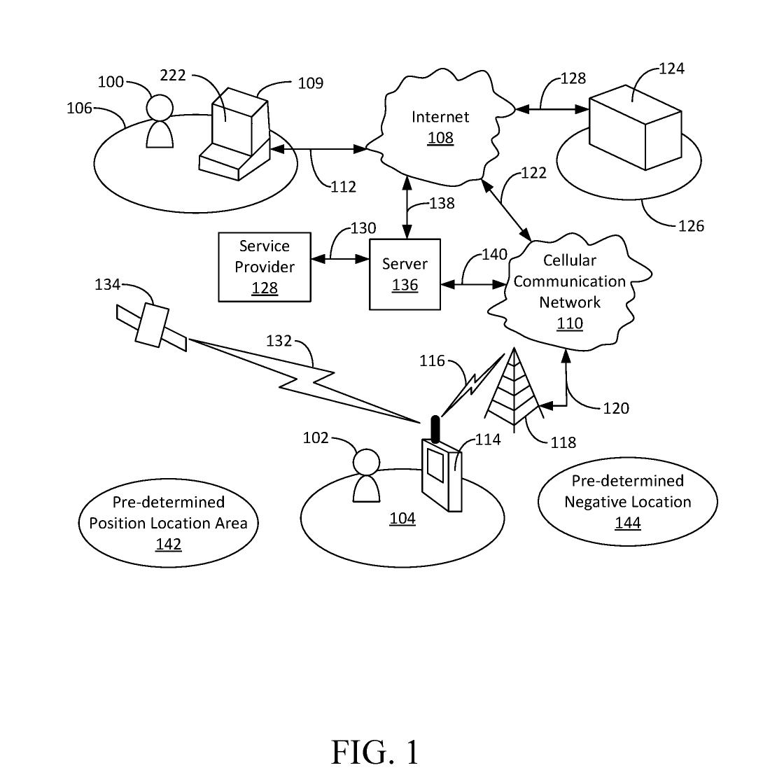

In FIG. 1, a system diagram of an example of an implementation of a telepresence system is shown, in accordance with the invention, for providing information to a user 100 through an agent 102 based on the location 104 of the agent 102, which is remote to the location 106 of the user 100. The telepresence system is in signal communication with the Internet 108 and a wireless communication network 110. In this example, the user 100 may utilize an online device 109, having a display 110, to communicate with the Internet 108 via signal path 112. The agent 102 may utilize a wireless device 114 to communicate with the cellular communication network 110 via a signal path that includes a wireless signal path 116 to a base station 118, which is in signal communication with the cellular communication network 110 via signal path 120. The cellular communication network 110 may be in signal communication with the Internet 108 via signal path 122. The telepresence system may also be in signal communication with a target 124, located at a target location 126, and a service provider 126 via signal paths 128 and 130, respectively.

It is appreciated by those skilled in the art that the circuits, components, modules, and/or devices of the telepresence system are described as being in signal communication with each other, where signal communication refers to any type of communication and/or connection between the circuits components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying digital formats without passing through a direct electromagnetic connection.

Turning back to FIG. 1, the online device 109 may be any computing device capable of connecting to the Internet 108 and having a display 110 capable of showing images or video captured by wireless device 114 of the agent 102 or provided by the service provider 126. Examples of the online device 109 may include a personal computer (both portable and non-portable), a computer tablet (such as, for example, an iPad®, Android® based tablet, or Microsoft® based tablet), a personal digital assistant (“PDA”), or smartphone (such as, for example, an iPhone®, Android® based smartphone, or Microsoft® based smartphone), or any other equivalent device. Similarly, examples of the wireless device 114 of the agent 102 may include a portable computer, a computer tablet (such as, for example, an iPad®, Android® based. tablet, or Microsoft® based tablet), a personal digital assistant (“PDA”), or smartphone (such as, for example, an iPhone®, Android® based smartphone, or Microsoft® based smartphone), or any other equivalent device. The wireless device 114 may also be incorporated into the agent 102 such as a module in a non-human agent 102 or in a wearable device or configuration (such as, for example, a helmet, headpiece, or wearable accessory) if the agent 102 is human. The wireless device 114 may also include location determination technology (“LDT”) circuitry that may include, for example, a global positioning system (“GPS”) module, an aided location communication system, a multilateration module, a Wi-Fi® identification module, or combination of these technologies that allow the determination of a location of specific wireless communication device. An example of an aided location communication system is described in U.S. Pat. No. 7,970,412, titled “AIDED LOCATION COMMUNICATION SYSTEM,” issued on Jun. 28, 2011, which is herein incorporated by reference in its entirety. In this example, the wireless device 114 is configured to receive satellite positioning signals 132 from a satellite position system 134 such as, for example, the United States NAVSTAR GPS, the Russian counterpart to NAVSTAR known as Global Navigation Satellite System (“GLONASS”), and the future European system known as Galileo.

The cellular communication network 110 may be any wireless communication network that allows the wireless device 114 to communicate with the Internet 108. Examples of the cellular communication networks include TDMA, CDMA, and GSM communication networks operated by United States cellular providers AT&T Wireless, Verizon, T-Mobile, or Sprint Communications.

The agent 102 may be a human, robot, other type of machine, or combination of human and machine. If human, the agent 102 may be a shopper, tourist, helper, representative, or avatar. The agent 102 may be equipped with one or more devices (such as wireless device 114) which may include processors and/or systems such as a smartphone, computer tablet, portable computer, or other means, equipped or associated with one or more cameras, microphones, haptic sensors, and/or chemical sensors that are capable of sensing and transmitting to the user 100 audio, video, haptic and/or chemical information (e.g., odors) (“environmental information”) proximate to the agent 102 at the location of the agent 104.

The agent 102 may be any person willing to work as an agent for the user 100 which is registered with the service provider 128. As an example, the agent 102 may be a tourist traveling in a foreign country with a wireless device 114 (that may be, for example, a smartphone, computer tablet, or personal computer) that is willing to help the user 100 by either going to specific places of interest to the user 100 to, for example, record video and/or audio or take pictures for the user that can be transmitted to the user's 100 online device 109 or to do specific tasks that may include purchasing items, communication with third parties, or other telepresence activities.

Additionally, the agent 102 may be a person that possesses certain skills or knowledge that is beneficial to the user 100. Specifically, the agent 102 may have language skills (i.e., the agent 102 may speak and/or read and write the language of the user 100 and/or the foreign location where the agent 102 is located) or familiarity with culture, geography, history, political environment of the user 100 and/or the foreign location of the agent 102. In this example, the agent 102 may provide the service provider 129 with a list of the skills and knowledge of the agent 102. The service provider 128 may then store and categorize the list of skills and knowledge corresponding to the agent 102 in the server 136 database and then provide this information to the user 100 who may utilize this information in selecting a potential agent. Moreover, the agent 102 may continuously provide the service provider 128 with information regarding the environment of the agent 102 such that the service provider 128 may update its database regarding this information. This environmental information may also be passed to the user 100 by the server 136.

As discussed above, the wireless device 114 may be incorporated into the agent 102 as a wearable device such as, for example, a helmet, headpiece, or wearable accessory. Alternatively, the wireless device 114 may be able to communicate (for example, utilizing Wi-Fi®, Bluetooth®, or other signal communication means both wired and wireless) with the other devices discussed above. As an example, one or more cameras and/or microphones, which are capable of sensing and transmitting (alone or via the wireless device 114) environmental information in the location 104 of the agent 102 to the user 100 are mounted or otherwise associated in a helmet, hat, bandana and/or elsewhere on, attached to, or in close association with the agent 102. As a further example, multiple cameras and/or microphones may be arrayed around the agent 102. The cameras may be standard cameras or part of a three-dimensional camera system.

Alternatively, as an example, if the agent 102 is a robotic device, the robotic device may include a display capable of displaying images arid/or audio of user 100 captured by the online device 109. In this manner a robotic device under the remote control of the user 100 may provide a communication means between the user 100 and store clerks and other persons, etc., encountered in places of interest to which the user 100 directs the agent 102.

The user 100 communicates with the agent 102 via the online device 109. As discussed earlier, the online device 109 may be any computing device capable of connecting to the Internet 108 and having a display 110 capable of showing images or video captured by wireless device 114 of the agent 102 or provided by the service provider 126. The online device 109 may be a personal computer, computer tablet, PDA, smartphone, or any other equivalent device. Additionally, the online device 109 may be configured to operate with one or more peripheral devices (not shown) that assist the user 100 in achieving a telepresence environment. Example peripheral devices may include multiple video displays (not shown), external speakers, external microphones, virtual reality glasses, and a virtual reality suit, all of which are in signal communication with the online device 109. The user 100 may also utilize the online device 109, or associated peripheral devices, to communicate and control aspects of the agent 102. For example, if the agent 102 possesses remote controllable cameras, the user 100 may control one of more of the cameras associated with the agent 102 such as, for example, the pan, tilt, and zoom, mechanical position of the camera or cameras.

In general, the telepresence system also includes a client module (not shown), an agent module (not shown), and a server 136. The client module (not shown) may be in signal communication with the online device 109 of the user 100 and the agent module (not shown) may be in signal communication with the wireless device 114 of the agent 102. The server 136 may be in signal communication with the client module (not shown), agent module (not shown), and both the Internet 108 and wireless communication network 110 via signal paths 138 and 140, respectively. The server 136 may also be in signal communication with the service provider 128 via signal path 130. In general, the server 136 may be configured to receive requests from the user 100 via the Internet 108 and location information from the agent 102 via the cellular telecommunication network 110 and, in response, provide telepresence information from e agent 102 to the user 100. Typically, the server 136 may be part of the service provider 128.

The service provider 128 may be an entity or organization that provides the user 100 with telepresence services such as remote shopping services, remote travel services, remote event participation services, and the like. The service provider 128 may provide the user 100 (via a website on the Internet 108 that is shown to the user 100 through the online device 109) with list of available agents from which to choose a specific agent 102 to satisfy the telepresence needs of the user 100. Alternatively, the service provider 128 may be more limited to only providing a website on the Internet 108 (that may be viewed and interacted with via the online device 109) inch the user 100 may utilize to contact and communicate with independent agents who provide telepresence services.

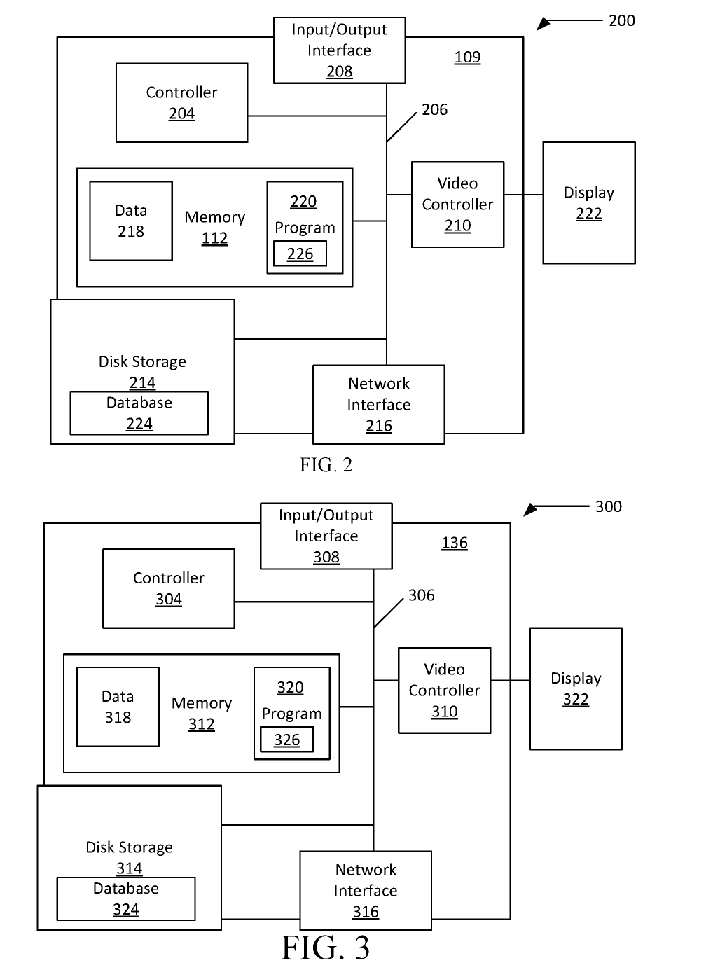

Turning to FIG. 2, an exemplary block diagram 200 of an online device 109 with a controller 204 in accordance with an example implementation of FIG. 1 is depicted. The controller 204 may be a microprocessor, microcontroller, digital signal processor, or a combination of digital and/or analog circuits executing a state machine. The controller 204 is shown as coupled to a data/address bus 206 that enables data to be transferred between components of the online device 109. The data/address bus 206 also provides communication to an input/output module 208, video controller 210, memory 212, disk storage 214, and a network interface 216. The memory 212 may be further logically or physically divided into a data memory 218 and a program memory 220. The data memory 218 is typically read/write type memory (commonly referred to as random access memory). Program memory 220 may be random access memory (RAM), written, or burned memory commonly called ROM that typically has instructions for execution by the controller 204. An example of a program contained in the program memory 226 is a client program for communicating with server 136. In other implementations, a single undivided memory may be used.

In FIG. 3, an exemplary block diagram 300 of server 136 with a controller in accordance with an example implementation of FIG. 1 is depicted. The controller 304 may be a microprocessor, microcontroller, digital signal processor, or a combination of digital and/or analog circuits executing a state machine. The controller 304 is shown as coupled to a data/address bus 306 that enables data to be transferred between components of the server 136. The data/address bus 306 also provides communication to an input/output module 308, video controller 310, memory 312, disk storage 314, and one or more network interface 316. The memory 312 may be further logically or physically divided into a data memory 318 and a program memory 320. The data memory 318 is typically read/write type memory (commonly referred to as random access memory). Program memory 320 may be random access memory (RAM), written, or burned memory commonly called ROM that typically has instructions for execution by the controller 304. An example of a program contained in the program memory 320 is webserver 326. In other implementations, a single undivided memory may be used.

The video controller converts 110 digital data into video data for display on a video monitor display 122 or other display device. The input/output interface 108 enables other devices to be coupled to and in signal communication with the processing unit 102. Examples of input/output interface 108 include universal serial bus, serial ports, parallel ports, and small computer serial interface (SCSI) ports, to name but a few. The network interface 116 may be an internet connection via wired and/or wireless connection that enables communication with other devices such as servers, clients, printers, and cloud based services.

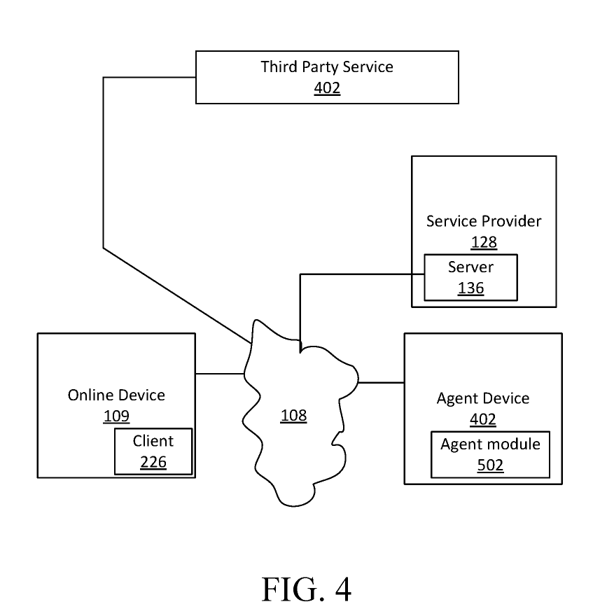

A remote travel service example is provided in FIG. 4 in accordance with and example implementations. A user at an online device 109 desires to travel to a different part of a city. A client 226 being executed by the user's online device 109 contacts a service provider's server 136. The service provider 128 may register potential agents and potential targets to which the user 100 may send an agent 102 to aid in fee calculation. The service provider 128 is contacted by the client 226 via the service provider's website 326 over the internet. The user's desired destination may be provided to the server 136 of the service provider 128 via the client 226. The location of the user of the client 226 may also be entered or otherwise provided to the service provider via communication between the client 226 and server 136 to request an agent. The user via the client 226 may control aspects of the agent, such as if the requested transportation is economy transportation, premium transportation, handicap accessibility transportation, carpool transportation. The service provider 128 via the server 136 provides a list of available potential agents (the list may only have one agent and is not required to be a plurality) based on the locations (i.e., starting locations) of the agent device 402 relative to the location 106 of the user 100. The selected agent 102 via the agent device 402 will be directed in response to user 100 to proceed to the location of the user. Thus, an agent 102 may be selected by the service provider 128 that is close to the user 100. When you arrive at the destination, the service provider may automatically charge the user via a third party connection 402 to the server 136, such as a credit card processing company. A fare estimator may also be provided by the server 136 of the service provider 128 enabling the user 100 to further control aspects of the agent. If the fair is too high, a user may wait for a different agent to be provided in the list. The service provider 128 may also provide the user 100 with additional information about each agent in the list including the agent's qualifications, such as languages spoken, travel knowledge, equipment, picture, and/or rating by prior users.

The service provider 128 may offer the list of available potential agents based on the locations (i.e., starting locations) of the individual potential agents relative to either the user 100 location 106 and/or the place(s) of interest (i.e., the target 124) to which the selected agent 102 will be directed by the user 100 so that an agent 102 may be selected that is close to the user 100 or the area(s) of interest to which the agent 102 will be directed. As an example, if the user 100 desires to engage the telepresence services of an agent 102 to remotely shop for the user 100 and purchase goods at a target 124 (for example, a local department store) that will be delivered by the agent 102 to the user 100, the user 100 may want to select an agent 102 that is nearby the location 106 of the user and/or the location 126 of the target 124 (i.e., the department store). In this example, the service provider 128 may limit the list of potential agents available to the user 102 to a sub-list of potential agents available to the user 102 based on the location 106 of the user and/or the location 126 of the target 124 (i.e., the place of interest to which the agent 102 will be directed by the user 100). The user 100 may then select the agent 102 from the sub-list of the potential agents available utilizing the online device 109. In order to assist the user 100 in selecting an agent 102, the service provider 128 may also provide the user 100 with additional information about each potential agent including the agent's qualifications, such as languages spoken, camera skills, number and types of cameras (whether three-dimensional or controllable), number and types of microphones, availability of other telepresence sensors, displays, and equipment, negotiation skills, travel knowledge, and/or rating by prior users, etc. This additional information may be displayed for the user 100 on the display 110 of the online device 109 to assist the user 100 in the selection of the agent 102 to provide the telepresence services to the user 100.

The service provider 128 may register potential agents and potential targets to which the user 100 may send an agent 102. In this example, the service provider 128 may create a database (not shown) of potential registered agents and their corresponding starting locations and potential registered targets and their target locations. This database (not shown) may be either in the server 136 or remote to and in signal communication with the server 136. The service provider 128 may then establish pre-determined positive location areas and pre-determined negative location areas that effect the transmission of information from the service provider 128 to the us the online device 109 of the user 100. Specifically, the service provider 128 may establish a pre-determined positive location area 142 that is a location area that triggers the transmission of information from the service provider 128 to the online device 109 of the user 100. Similarly, the service provider 128 may establish a pre-determined negative location area 144 that is a location area that triggers the termination of an existing transmission of information from the service provider 128 to the online device 109 of the user 100. Both the pre-determined positive location areas and pre-determined negative location areas may be pre-determined by the service provider 128 based on information received by the registered tan-lets.

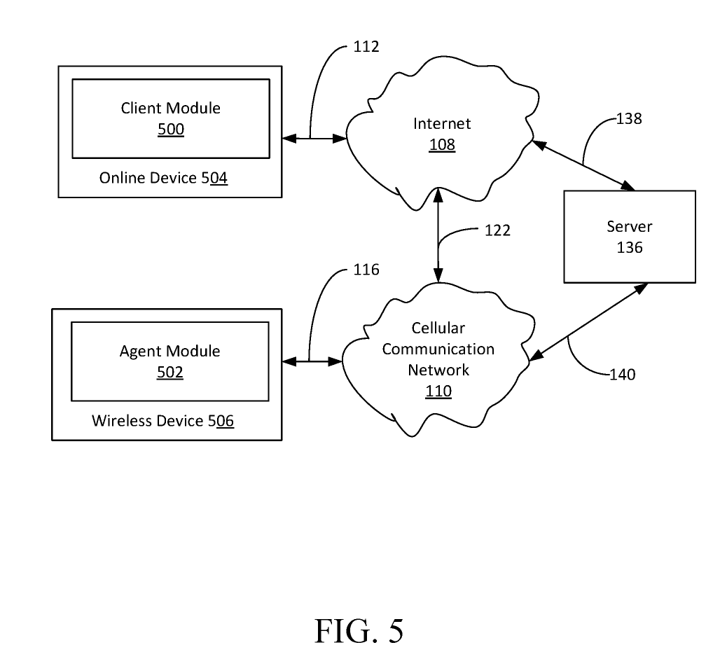

Turning to FIG. 5, a system block diagram is shown of the example of the implementation of the telepresence system having one or more cameras, shown in FIG. 1, including a client module 500 and an agent module 502. Specifically, the telepresence system shown in FIG. 5 includes the client module 500 in signal communication with the online device 504 and the agent module 502 in signal communication with wireless device 506. In this example the online device 504 is in signal communication with the Internet 108 via signal path 508 and the wireless device 506 is in signal communication with the cellular communication network 110 via signal path 510. Similar to FIG. 1, the server 136 is in signal communication with both the Internet 108 and cellular communication network 110 via signal paths 138 and 140, respectively.

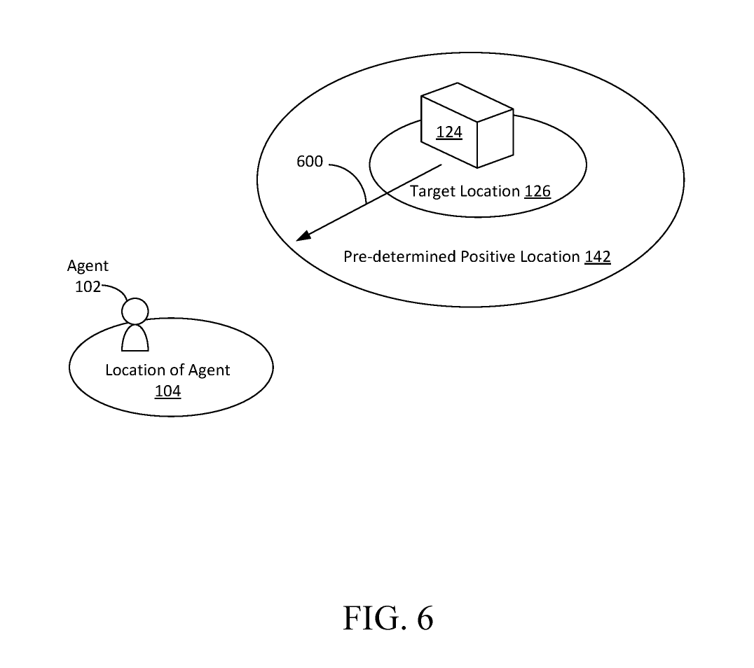

In FIG. 6, a perspective view of the respective locations 104 and 126 of the agent 100 and a registered target 124 are shown in relation to a pre-determined positive location 142, in accordance with the invention. In this example, if the registered target 124 is a business establishment or organization, the target 124 may desire to have business related information such as, for example, advertising information sent to the user 100 once the agent 102 of the user 100 enters within the pre-determined positive location area 142 that corresponds to the target location 126. In this example, the target 124 may send advertising information to the server 136 to send to users who have agents that enter into the pre-determined positive location area 142 corresponding to the target 124 where the pre-determined positive location area 142 is an extending circular area that extends out from the location 126 of the target 124 and has a radius 300.

In an example of operation, if the server 136 determines that the agent 104 enters into the pre-determined positive location. area 142 (i.e., the location 104 of the agent 100 overlaps the pre-determined positive location area 142), the server 136 then transmits the business related information from the target 124 to the online device 109 of the user 100. The business related information may be advertising information such as, for example, electronic coupons.

In another example of operation, the telepresence system allows for real-time competition between competing businesses. As an example, if the user 100 directs the agent 102 to go to a first store in a shopping mall which also includes a second store belonging to a competitor (which is also registered with the service provider 128), the competitor may be able to have the service provider send the user 100 advertisements, electronic coupons, or other business related information that would entice the user 100 to send the agent 102 to the second store instead of the first store. In this example, the competitor may contract with the service provider to set up a plurality of pre-determined positive location areas to entice the user 100 such as a pre-determined positive location area within, for example, 100 feet of the first store and/or 2000 feet from the second store. In this type of example, there may be numerous stores registered with the service provider that each have one or more pre-determined positive location areas which may overlap other stores pre-determined positive location areas. The end result being that the user 100 would receive multiple offers from different stores when the agent 102 enters an area that overlaps multiple pre-determined positive locations.

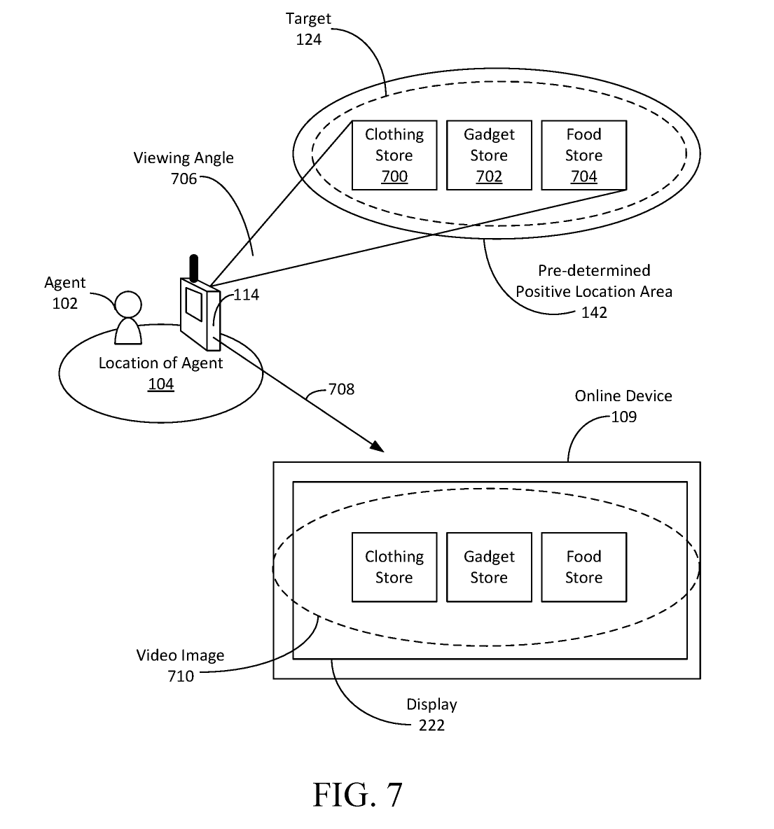

Turning to FIG. 7, a system view of an example of a video transmission from an agent 104 to an online device 109 of a user 100 utilizing the telepresence system shown in FIG. 1 is shown. In this example, the agent 100 is outside of the pre-determined positive location area 142 and taking pictures and/or video of the front of target 124 which includes a clothing store 700, gadget store 702, and food store 404. The agent 102 utilizes a camera (not shown) on the wireless device 114 to take video of the front of the target 124 with a viewing angle 406 that includes the clothing store 700, gadget store 702, and food store 704 within the viewing plane of the camera. The camera creates a video signal 708 that is transmitted to the online device 109 and displayed as a video image 710, on display 110 of the online device 109, showing the clothing store 700, gadget store 702 of the target 124. As described earlier, the video image 410 is telepresence information that is transmitted from the agent 102 to the user 100, which the user 100 may utilize in determining where to send the agent 102. If the user 100 desires clothes, the user 100 instructs the agent 102 to proceed to the clothing store 700. Similarly, if, instead, the user 100 desires either a gadget or some food, the user may instruct the agent 102 to proceed to the gadget store 702 or food store 704, respectively.

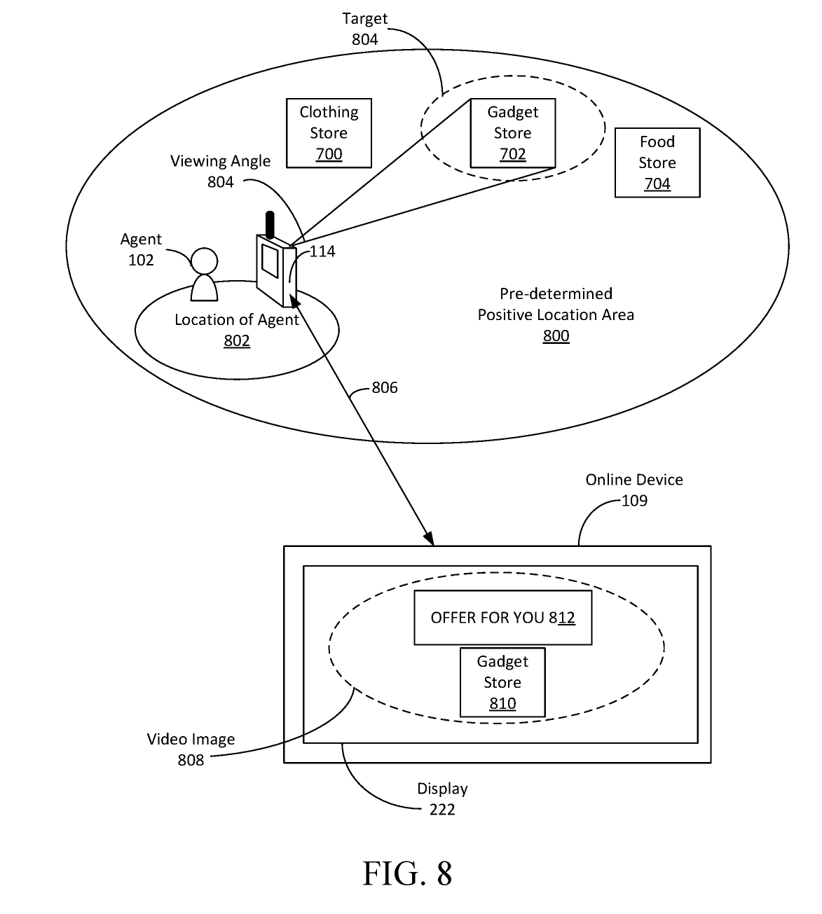

Expanding on the example described in FIG. 7, in FIG. 8, a system view is shown of an example of a video transmission from the agent 100 and service provider 128 to the online device 109 of the user 100 when the agent 102 enters into the pre-determined positive location area 142 utilizing the telepresence system. In this example, the user 100 has decided to send the agent 100 to the gadget store 702, which is a registered target of the service provider 128. Once the agent 102 enters into the pre-determined positive location. area 800 of the gadget store 702, the wireless device 114 of the agent 102 transmits its new location 802. Once the server 136 receives the new location 802 of the agent 102, it determines that the location 802 of the agent 102 is within the pre-determined positive location are of the gadget store 702 (i.e., the target 804) and in response sends the user 100 advertising and/or sale information corresponding to the gadget store 402. If the agent 102 utilizes the camera of the wireless device 114 to video the front of the gadget store 702 with a viewing angle 804, camera creates a video signal 806 that is transmitted to the online device 109. However, unlike the example given in FIG. 4, in this example the service provider 128 also provides advertising and/or sale information corresponding to the gadget store 702 which is combined with the video signal 806 to produce a video image 808 on the display 110 of the online. device 109 that includes an image of gadget store 810 and an advertising and/or sale image 812 having advertising and/or sale information related to the gadget store 702.

The advertising and/or sale information may be time limited such that, for example, sale prices are only good if the agent 102 enters the gadget store 702 within a certain time and purchases a sales item. The server 136 is capable of keeping track of sales offers from targets to one or more agents that are conditional on location or time.

In a social, non-business application, the service provider 128 may register individuals in a social club or organization. The service provider 128 may then use pre-determined positive location areas to determine if a member's agent 102 is near another member and/or another member's agent (not shown). If yes, the service provider 128 may notify both members and offer to start either direct communication between the members or indirect communication between agent-and-member or agent-and-agent. A possible application for this would be when one member needs to give an item to another member. In this example, the first member may give the item to the second member's agent who will them take the item to the second member.

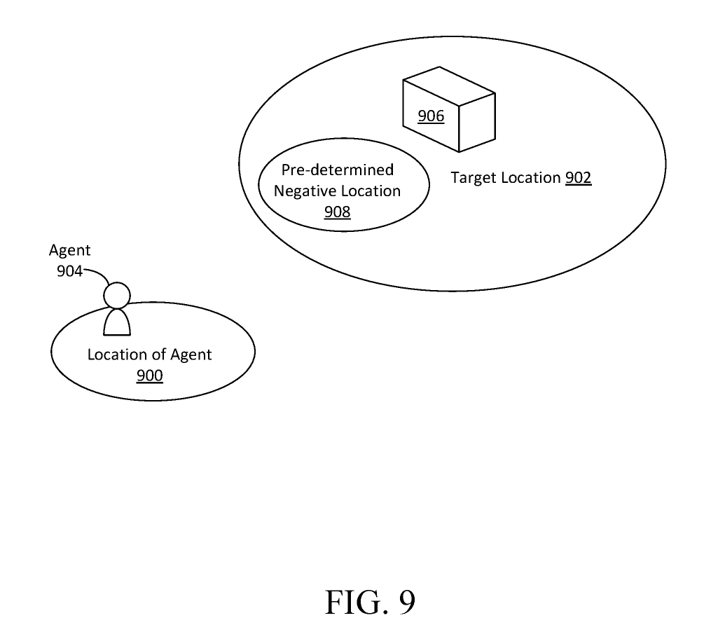

Turning to FIG. 9, a perspective view of the respective locations 900 and 902 of the agent 904 and a registered target 906 are shown in relation to a pre-determined negative location 908 in accordance with the invention. In this example, if the registered target 606 desires to have one or more pre-determined negative location areas 908 blocked from the user 100, the target 606 sends that information to the service provider 128. In this example, if the agent 904 is transmitting telepresence information to the user 100 and the server 136 determines that the agent 604 has entered into the pre-determined negative location 908, the server 136 terminates transmission of some or all telepresence information from the agent 904 to the online device 109 of the user 100. An example of this application would be if the target 906 designates a washroom, changing/locker room, or other sensitive area as a pre-determined negative location area 908. In this example, the target 606 may condition what type, if any, telepresence information may be transmitted from the agent 604 to the user 100. As an example, the target 906 may allow the transmission of audio without video in a washroom or changing room but not in a place like a concert hall or meeting room. The pre-determined negative location areas 908 may be designated to protect privacy, personal information, copyrighted material, etc.

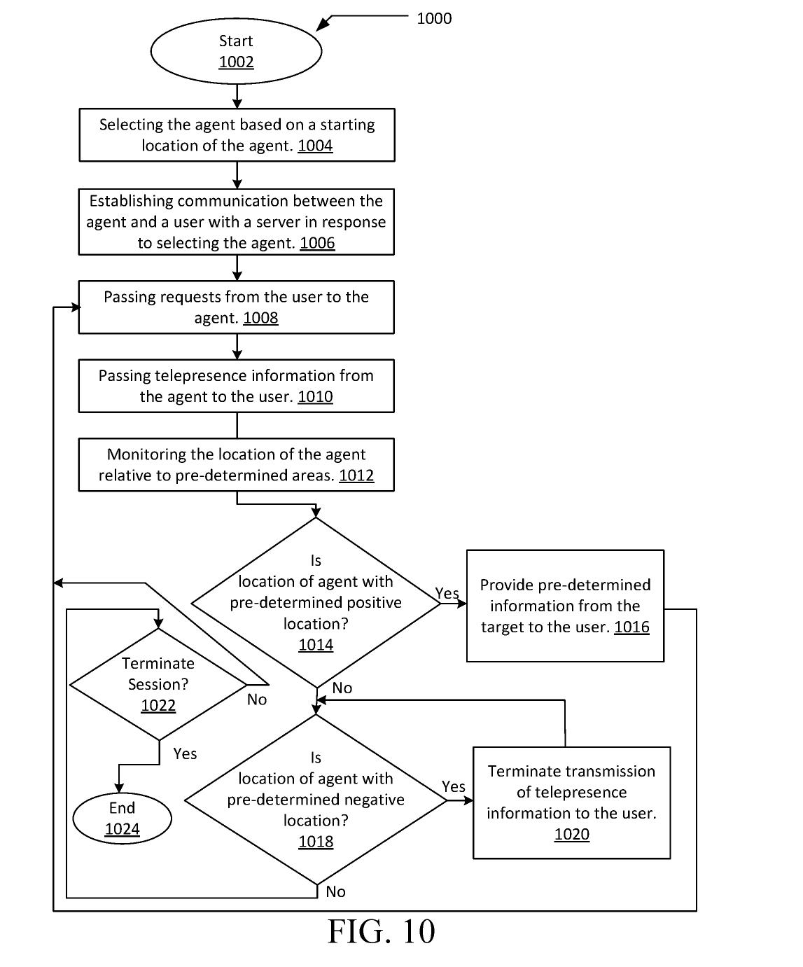

In FIG. 10, a flowchart 1000 of an example of an implementation of a process performed by the telepresence system of FIG. 1 is shown in accordance with the invention. In general, the telepresence system allows a user to establish a telepresence with an agent via the Internet and a cellular communication network. In an example of operation, the telepresence system performs a process that starts 1002 by establishing communication between the user and the agent via the Internet and cellular communication network. The process establishes this communication by selecting the agent based on a starting location of the agent in step 1004 where this includes selecting the agent based on the starting location of the agent relative to the either a location of the user or a location of target. This selection may be done in combination between the user and the service provider. Then in step 1006, in response to the agent selection, a server establishes communication between the user and the agent. Once communication is established between the agent and user, the server receives requests from the user and passes them to the agent in step 1008. In response to the user's requests, the agent gathers telepresence information and sends it to the server which in step 1010 passes it to the user. The server then monitors the location of the agent in step 1012 using location information provided by the agent's wireless device and compares it to various pre-determined areas (both positive and negative) provided by different registered potential targets. In decision step 1014, the server checks to see if the agent has entered into a pre-determined positive location area of a registered target. If the answer is yes, in step 1016, the server provides to the user pre-determined information, which was provided to the service provider by the target. The process then continues to step 1008 and repeats.

If, instead, the answer is no, the process continues to decision step 1018 where the server checks to see if the agent has entered into a pre-determined negative location area of the registered target. if the answer is yes, in step 1020, the server terminates the transmission of at least some telepresence information from the agent to the user. The process then repeats decision step 1018, where the server continues to regularly compare the location of the agent against the pre-determined negative location area to see if agent is still located in the pre-determined negative location. If the agent leaves the pre-determined negative location area, the process travels from decision step 1018 to decision step 1022.

If, instead, the answer is no, the process continues to decision step 1022 where the server check to see if the user or agent have terminated the session. If the answer is yes, the process ends 1024. If, instead, the answer is no, the process repeats by returning to step 1008.

### Target Identification

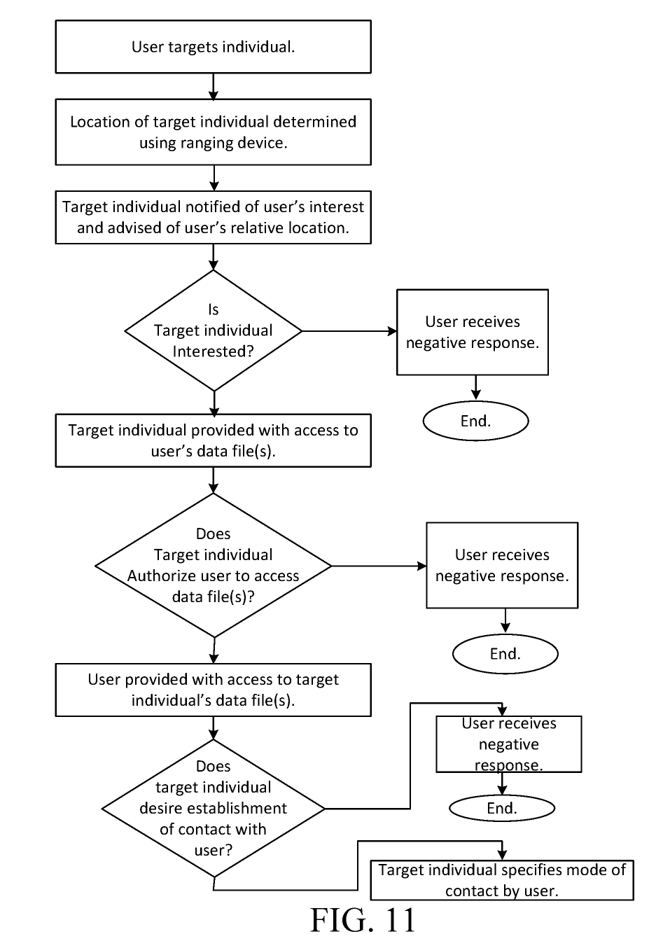

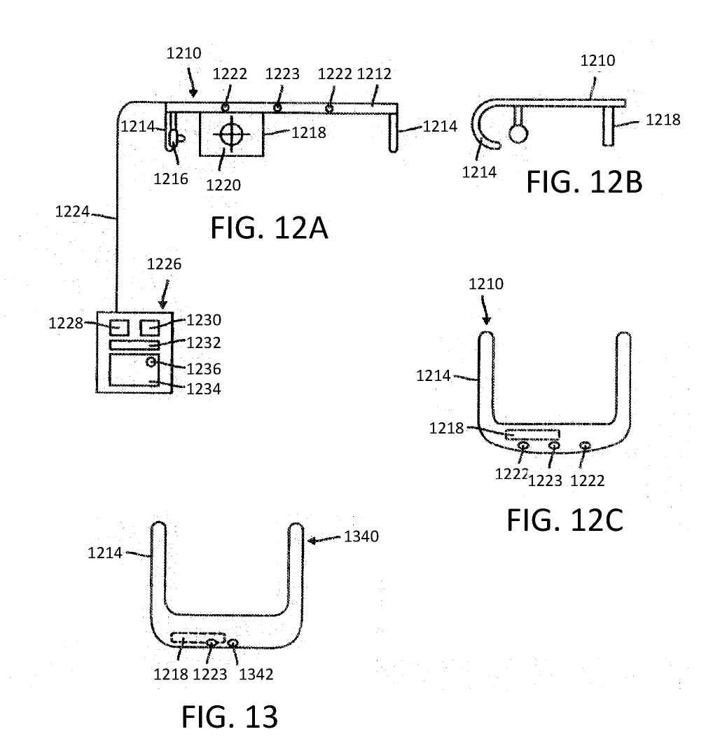

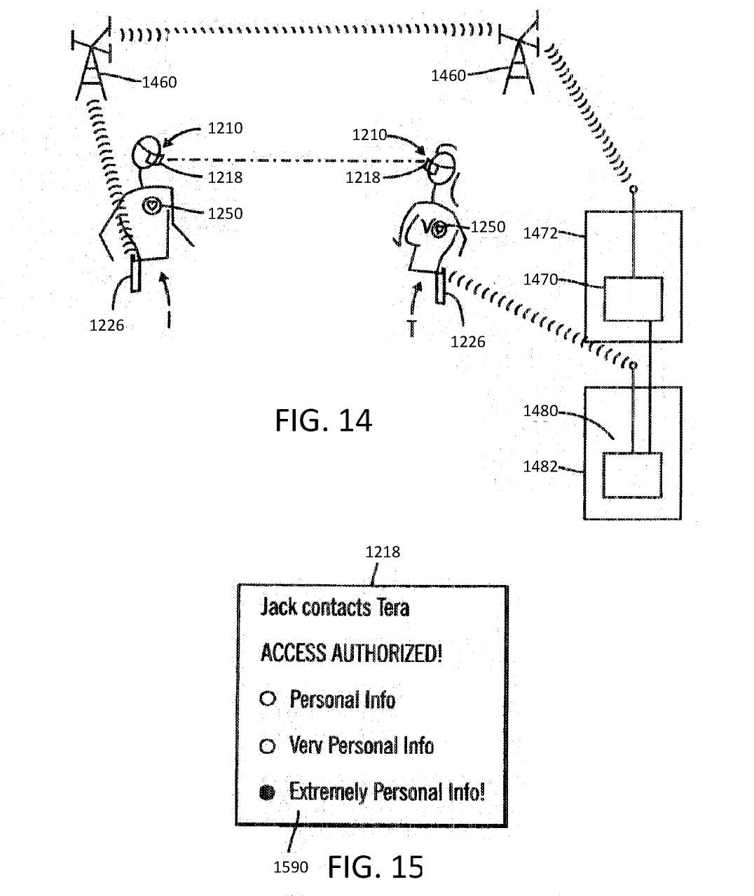

Turning now to the embodiment illustrated in FIGS. 11, 12A-C, and 14, an inquiring individual “I” (generally, a “user”) first targets an individual of interest. Preferably, the target individual “T” is visually identifiable as a member of a remote dating organization, and more preferably as a member of a remote dating organization to which the inquiring individual belongs or which is affiliated with the inquiring individual's organization. Such visual identification can be accomplished, for example, by the target individual's use of a membership device such as a device 1210 with a heads-up display (HUD) 1218, an LED, a badge 1250 of FIG. 14, or another visual indicator. Very preferably, the target individual also is equipped with a transmitter, an Internet connection or the like, (e.g., integrating processing/transceiving unit 1226 of FIG. 12A, as discussed further below), that provides the target individuals location (e.g., GPS coordinates) to a central location maintained by the remote dating organization to which the target individual belongs. In preferred embodiments, the target individual's location is periodically or continually updated in order to account for movement by the target individual.

Next, the inquiring individual determines the location of the target individual, more particularly the location of the target individual relative to the inquiring individual's location. The distance between the inquiring individual and the target individual is determined using a ranging device. Appropriate ranging devices include, without limitation, a device having an element that determines the range to a target based on the eye positions of the inquiring individual (e.g., using a cross-hairs element); an infrared pointer device; an ultrasonic device, or any other ranging device. See, e.g., cross-hairs element 1220 and sensors 1222 of headset 1210 of FIGS. 12A-C, discussed below.

Preferably, the inquiring individual also carries an element, such as a GPS locator, that provides the inquiring individual's location, as well as the orientation of the inquiring individual (i.e., the direction in which the inquiring individual is facing). The inquiring individual's location and orientation, together with the location of the target individual relative to the inquiring individual, thus can be used to determine the location of the target individual.

Once the location of the target individual has been determined, this location is transmitted to a central location 1470 of FIG. 14, in particular to a central computer operated by the remote dating service 1472 to which the inquiring individual belongs. In particular embodiments, the information is transmitted via wide-area network 1460 of FIG. 14, such as the Internet, using a device carded by the inquiring individual, such as unit 1226 of FIG. 12A, a personal data manager, a cellular telephone having Internet accessibility, etc. Alternatively, the information can be transmitted by other means such as telephonically (e.g., by the inquiring individual accessing an appropriate telephone number of the remote dating service and providing the GPS coordinates of the target individual verbally or by using the telephone's keys).

### Target Contact

When the central location is provided with the location of the target individual, the central location 1470 of FIG. 14 contacts the target individual, either directly or via a second central location 1480 maintained by an affiliated remote dating organization 1482 to which the target individual belongs. In particular embodiments, the central location correlates the location information provided by the target individual, as discussed above, with the location information provided by the inquiring individual, in order to identify and then contact the correct target

Contact with the target individual can be affected in various ways. In particular embodiments, the target individual is contacted via a device including a heads-up display (HUD) 1218 of FIG. 12A and optionally an earphone 1216, worn by the target individual (see FIG. 12A); telephonically, for example, via a cellular telephone; via a wide-area network accessible by the target individual by use of a personal data manager; or by any other communication device.

Upon contact, the target individual is notified that the inquiring individual is interested in contacting her/him. In particular embodiments, the target individual is first advised that someone, not further identified, is interested in making contact. The target individual is then given the option of receiving more information concerning the person expressing interest (i.e., the inquiring individual) at which point the target individual is notified of the location of the inquiring individual. The target individual can then look toward the inquiring individual's location and visually identify the inquiring individual before deciding whether or not to receive further information and/or establish contact. In other particular embodiments, the target individual is provided with the inquiring individual's location immediately.

Having been provided with the inquiring individual's location, the target individual is then afforded the option of receiving further information concerning the inquiring individual. If the target individual is not interested, the target individual can provide a negative response to the central location by any desired means (e.g., telephonically, via an HUD, via a hand-held unit with access to a wide-area network such as the Internet, and the like), which the central location then relays to the inquiring individual. Alternatively, the target individual can simply elect not to respond. After a predetermined time, this lack of response constitutes a negative response by default, and the negative response again is relayed by the central location to the inquiring

### Positive Response by Target

On the other hand, if the target individual desires to receive further information concerning the inquiring individual, the target individual provides a positive response to the central location. The central location then provides the target individual with additional information about the inquiring individual. In particular embodiments, the central location provides to the target individual a menu 1590 (see FIG. 15) listing one or more data files containing information about the inquiring individual. Such files can include, without limitation, text files including the inquiring individual's biographical information, including professional information, awards received, etc.; files containing photographic images of the inquiring individual, the inquiring individual's residence, personal vehicle(s), boats and the like, art works created by the inquiring individual, etc.; audio files including readings by the inquiring individual, musical works, and the like; video files featuring the inquiring individual, news articles; and any other digital data file, data stream, and the like. The inquiring individual then selects one or more data files of interest from the menu.

The data files containing information about the inquiring individual can be accessed by the target individual using various devices. In particular embodiments, the target individual accesses the data files using a device for accessing the Internet or other wide-area network, together with an HUD on which the information in the files is displayed and, in more particular embodiments, an earphone or other device for conveying audio information.

After accessing one or more data files containing information about the inquiring individual, the target individual is then afforded the choice of whether to allow the inquiring individual to access one or more data files containing information about the target individual. If the target individual chooses to deny access to the inquiring individual, or defaults by not making a choice within a predetermined time period, a negative response is provided to the central location and thence to the inquiring individual. If, on the other hand, the target individual finds the inquiring individual of interest and wishes to grant access to the target individual's data file(s), the target individual provides a positive response to the central location. The central location then provides the inquiring individual with access to one or more of the target individual's data file(s). The inquiring individual then accesses the target individual's data file(s) in particular embodiments in a manner similar to that described above.

In more specific embodiments, the target individual specifies the level of disclosure depending on various circumstances, such as age, desired degree of intimacy with the inquiring individual, previous acquaintance with the inquiring individual, etc. Thus, the target individual could specify that files containing basic information, such as age, educational background, interests, etc. are to be made accessible to inquiring individuals with whom the target individual is not already familiar, while files containing more intimate information, such as photographs, favorite activities, etc. are to be made accessible to inquiring individuals with whom the target Individual is already familiar or with whom the target individual desires a more intimate relationship. For example, assuming that the target individual has previously classified his/her data. files into three levels of disclosure, the target individual could provide a response to the central location granting the inquiring individual access only to those files classified as level 1. If the target individual fines the inquiring individual more desirable or wishes to allow greater access to his/her files, the target individual could provide a response to the central location granting the inquiring individual access to level 2 or level 3 files. Preferably, higher level access also allows the inquiring individual to access lower level files as well.

### Initiation of Contact

Having authorized the inquiring individual to access his/her data file(s), the target individual is then afforded the option of authorizing personal contact by the inquiring individual. At this point, the target individual can still change his/her mind and provide the central location with a negative response, or can default by not providing any response; in either event, the central location then provides a negative response to the inquiring individual. Alternatively the target individual can provide a positive response to the central location authorizing the inquiring individual to establish personal contact with the target individual. In particular embodiments, the target individual is given the option of specifying the mode of contact. For example, the target individual is provided with a menu including telephonic or e-mail contact, personal contact at the present time, personal contact at a later time and/or at a different location (specifiable by the target individual, for example by typing in the appropriate time and/or location using a keyword or other input device), and the like.

In one particular example, the target individual provides the central location with a response authorizing the inquiring individual to make personal contact at the present location of the target individual. The central location relays this authorization to the inquiring individual, who then proceeds to establish personal contact with the target individual.

In the embodiment illustrated in FIG. 11, such a negative response ends the procedure. In the alternative, the target individual is afforded the option of denying the inquiring individual access to his/her data files, but nevertheless to specify whether or not to authorize the inquiring individual to establish personal contact.

Once the inquiring individual has initiated personal contact with the target individual, particular embodiments of the invention facilitate further interaction. Thus, particular embodiments provide the inquiring individual with menus containing suggestions for “ice breaking,” such as topics for conversation, witty sayings, jokes and the like, in order to assist the inquiring individual who is shy or lacks self-confidence.

According to other particular embodiments, the data files to which the target individual grants the inquiring individual access can include a listing of the target individual's beverage preferences. The inquiring individual asks the target individual if he/she would like a drink. After a positive response, the inquiring individual accesses the beverage preference file, identifies a beverage preferred by the target individual, and orders the beverage. In very particular embodiments in which the inquiring individual and the target individual initiate contact in an establishment which is also affiliated with the inquiring individual's organization, the inquiring individual is provided, e.g., by the central location, with means, such as a menu, for placing an order for the desired beverage. In such embodiments, the inquiring individual selects the desired beverage, places the order with the establishment (e.g., a bartender, waitress, etc., equipped with an appropriate data receiving device), authorizes payment via a credit card or other payment means, and then proceeds to an appropriate location to obtain the ordered beverage.

In other particular embodiments, the data files to which the target individual grants the inquiring individual access can include a menu of songs or other musical performances preferred by the target individual. By accessing this file, the inquiring individual can determine the extent to which the target individual shares the inquiring individual's tastes in music. Furthermore, in very particular embodiments in which the inquiring individual and the tan-let individual establish contact in a location that plays music, such as a nightclub, discotheque, etc., the inquiring individual can select one or more songs or musical performances and request that the selections be played, e.g., by a DJ, band or other performer at the location. In other very particular embodiments in which the inquiring individual and the target individual are equipped with a headset or other means for reception of audio transmissions, the inquiring individual can select one or more songs or other musical performances from the target individual's list of preferences and submit the selections to the central location. The central location then provides both the inquiring individual and the target individual with an audio stream of the selected song(s) and/or musical performance(s). Thus, the inquiring individual and the target individual are enabled to listen and/or dance to their own selected music, independently of the musical environment (if any) of the location in which they are present.

In related embodiments in which both the inquiring individual and the target individual are equipped with a headset or other means for the reception of audio transmissions, the inquiring individual and the target individual are enabled to communicate with each other via the central location such embodiments are particularly beneficial in noisy environments in which vocal communication is otherwise difficult, such as in nightclubs, concerts, and the like. Such embodiments need not rely on the central location, however. In alternative embodiments, the inquiring individual and the target individual can be equipped with wireless microphone devices or other means for short-range communication. Once the inquiring individual and the target individual agree to establish contact, each provides the other with information (e.g., frequencies, contact protocols, etc.) to enable communication via their wireless microphone devices or other communication means. In very specific embodiments, such communication devices can be provided to the inquiring individual and the target individual by a third party, for example a commercial establishment such as a bar or nightclub that each is patronizing. The devices can be provided to each person upon entry to the establishment and returned by each person when that person leaves the establishment.

### Subsequent Interaction

Additional specific embodiments provide suggestions for subsequent activities after the inquiring individual and the target individual establish contact. In one embodiment, the inquiring individual is provided with a menu listing suggestions for a first date with the target individual. The menu can include, in specific embodiments, a listing of restaurants, movie theaters, nightclubs, discotheques, and the like. In more particular embodiments, one or more of the listed options includes a link to a web site maintained by the selected establishment, or enables access by the inquiring individual to another data file pertaining to the selected establishment, by means of which the inquiring individual can obtain additional information concerning the establishment, such as days and hours of operation, screening schedules, pricing information, location of and directions to the establishment, weather conditions at the establishment, etc. In other particular embodiments, selection of a listed option by the inquiring individual accesses one or more advertisements for special packages of goods or services, special discounts, etc. Furthermore, the menu can include listings which are categorized according to price, location, ratings by independent rating services such as the ZAGAT® Guides, MICHELIN® Guides AAA® (American Automobile Association) Guides, etc.

In further embodiments, the inquiring individual is provided with one or more menus providing suggestions for subsequent dates with the target individual (such menus can also be accessed for first-date purposes if desired by the inquiring individual). Exemplary menus can include “frequent customer” packages that provide increasing benefits to the inquiring individual depending on the number of times a particular establishment is patronized by the inquiring individual and the target individual. Other exemplary menus can include listings of hotels, motels, resort locations and the like which may be of interest to the inquiring individual and/or the target individual. According to very particular embodiments, the inquiring individual is provided with a menu listing hotels and motels. The inquiring individual selects a hotel or motel of interest, and is then enabled, in more specific embodiments, to reserve and authorize payment for a room at the selected hotel or motel. Upon arrival at the hotel or motel, the inquiring individual can pick up his/her key and proceed to the selected room. Furthermore, according to further specific embodiments, the inquiring individual is provided with additional menu selections that enable the inquiring individual to order and arrange payment for flowers, champagne or other beverages, dessert items and the like, as well as other useful items such as condoms, and to request that the selected items by delivered to the selected room prior to the inquiring individual's arrival at the hotel or motel. Upon arrival at the selected room, the requested items are ready for use by the inquiring individual and the target individual.

Additional particular embodiments provide the inquiring individual with a record of previous choices, thus allowing the inquiring individual to avoid undesired repetition,

An inquiring individual and/or a target individual may wish to create a record of one or more contact and/or dates. Thus, according to particular embodiments, the inquiring individual and/or the target individual is provided with a menu option by the central location that enables creation of a contact/dating record. For example, the inquiring individual can create a record for a target individual that includes copies of one or more of the data files to which the target individual granted the inquiring individual access; an evaluation of the inquiring individual's initial contact with the target individual; evaluations of one or more subsequent dates with the target individual; and the like.

After a positive contact, the inquiring individual may desire to send a card, flowers or other gift items to the target individual. However, the target individual, for example due to security concerns, may not yet have provided the inquiring individual with her address or other personal information. Particular embodiments of the inventive method enable the inquiring individual to send one or more items to the target individual without knowing the target individual's address. The central location provides the inquiring individual with a menu including an option for delivery of a gift item to the target individual. When the inquiring individual selects this option, the request is transmitted to the central location, which has the target individual's address.

The central location then transmits an order for the selected gift item to be delivered to the target individual's address, without providing that address to the inquiring individual.

For purposes of security, a target individual may desire to verify the identity of an inquiring individual with whom she/he has established contact. Additional specific embodiments of the inventive method provide the target individual with the option to access one or more data files of the inquiring individual that include information identifying the inquiring individual. For example, the inquiring individual can provide the central location with one or more identification files including a copy of his/her birth certificate, his/her age, his/her educational record, employment history, medical history, records of marriage, divorce, paternity and/or orders for child support, credit report, history of arrests, convictions and/or other incarcerations (e.g., for DUI, sexual assault, etc.), copies of business cards, and the like. Before the target individual authorizes personal contact by the inquiring individual, or at a subsequent time after initial contact is established, the target individual can request access to one or more of the inquiring individual's identification files. Upon inspection of the inquiring individual's identification file(s) if the target individual is satisfied that the inquiring individual's background is acceptable, the target individual can then authorized contact or grant the inquiring individual access to the target individual's files, in a manner similar to that described above. If the target individual is not satisfied, for example if the inquiring individual has not provided the central location with any identification data files, then the target individual can decline to authorize contact by the inquiring individual or take other appropriate action.

In additional specific embodiments, one or more of the inquiring individual's identification data files can include hyperlinks to independent web sites useful for verification of the data included in the files. For example, if one of the inquiring individual's identification files states that the inquiring individual is employed by a specific employer, the file can also include a hyperlink to a web site maintained by the employer. The target Individual can then access the employer's web site to confirm that the inquiring individual is in fact employed by the employer. Alternatively, the central location can offer the target individual a menu including an option of contacting an independent verification service to verify that that data included in the inquiring individual's identification data file(s) is correct. In the event that some or all of the inquiring individual's identification data files are determined to contain inaccurate or fraudulent data, the target individual can then decline to authorize contact by the inquiring individual or take other appropriate action.

In a further refinement of the foregoing embodiments, the inquiring individual provides the central location (or alternatively, an independent database) with one or more files containing biometric data, for example, DNA identification, retinal scans, fingerprints, facial recognition scans etc. Upon establishing contact with the target individual, the inquiring individual then permits the target individual to obtain biometric data from the inquiring individual and compare the data so obtained with the data maintained in the inquiring individual's biometric identification file(s) by the central location or other independent database. Such biometric data can be obtained, in particular embodiments, by a portable unit for scanning fingerprints, retinal patterns or facial features, or by a portable unit for obtaining and analyzing a blood sample (which can include, for example, a biochip or other device). The target individual can then submit the biometric data so obtained to the central location or other independent database for verification. After a positive result, the target individual can authorize further interaction with the inquiring individual. On the other hand, after a negative result, the target individual can decline further interaction with the inquiring individual. In very specific embodiments, the biometric data obtained by the target individual may identify the inquiring individual as being wanted by one or more governmental authorities (i.e., the police, the INS, etc.), in which case the target individual can notify the appropriate authority.

In related particular embodiments, the target individual is equipped with a device for determining whether or not the inquiring individual is under the influence of one or more intoxicants or other controlled substances (e.g., a Breathalyzer unit). The target individual can request that the inquiring individual submit to a test for intoxication prior to accompanying the inquiring individual in a motor vehicle. If the test results indicate that the inquiring individual is intoxicated, the target individual can then decline to accompany the inquiring individual in a motor vehicle, arrange for alternative means of transportation, or take other appropriate action.

Under certain circumstances an inquiring individual may desire to have records created of his/her movements and/or the individuals the inquiring individual attempted to establish contact with or who attempted to establish contact with the inquiring individual. Such a record could, for example, enable the police or family members to attempt to locate him/her in the event the inquiring individual fails to contact family members for a predetermined period of time. Particular embodiments of the inventive method afford the inquiring individual the option of authorizing the central location to create a data file in which the inquiring individual's GPS location and/or contacts are periodically recorded. The inquiring individual is further afforded the option of authorizing one or more third parties to access the location and/or contact files, for example by contacting the central location by means of the Internet, telephonically or by other means.

A variant of the foregoing embodiment affords a third party, for example a parent or guardian of an inquiring individual, to request that the central location create such location and/or contact data files. This parental monitoring function, in specific embodiments, can be performed without the knowledge of the inquiring individual. The monitoring function can also be performed by other parties, such as parole officers.

On the other hand, under certain circumstances the inquiring individual may desire that no such record of his/her movements are made or kept. For example, the inquiring individual may wish to patronize a particular establishment, such as an adult entertainment establishment, without a record being kept of such patronage. More generally, an inquiring individual may not desire to have a continuous recording of his/her movements be created, in order to protect his/her privacy. In specific embodiments of the inventive method, the inquiring individual is afforded the option of disabling the GPS locating function unless and until the inquiring individual instructs the central location to activate the GPS locating function.

In other specific embodiments, the GPS locating function is activated automatically when an inquiring individual patronizes an establishment, such as a nightclub, discotheque, restaurant or the like, which is affiliated with the inquiring individual's organization. The GPS locating function is deactivated when the inquiring individual leaves the establishment. The inquiring individual can also request (for example, through selection of an appropriate menu option) that the central location record, or not record, the inquiring individual's GPS locations while the inquiring individual is present at the establishment, in a manner similar to that described above. In more specific embodiments, the inquiring individual is provided with menu options that allow the inquiring individual to selectively enable or disable recording of the inquiring individual's GPS locations by the central location.

The foregoing embodiments are typically useful at a fixed location, such as a nightclub, bar, restaurant, or other similar establishment, or at a site such as a high school auditorium where social events such as dances are held. However, embodiments of the inventive method are also useful even when the inquiring individual and the target individual are not in a fixed location, but rather are each in a moving location such as an automobile, boat, or the like. Thus, in particular embodiments, an inquiring individual driving, for example, an automobile visually identifies a target individual driving another automobile and desires to establish contact with the target individual. If the target individual is a member of the inquiring individual's organization, then the inquiring individual is enabled to transmit a request to the central location to initiate contact by, for example, providing the central location with an identification number, license plate number or other identifying indicium which the target individual has previously provided to the central location and has also placed in a location that is visible to the inquiring individual. In an alternative embodiment, the inquiring individual determines the location of the target individual by GPS means, in a manner similar to that previously described. Once the target individual has been identified, by identifying indicium or by GPS location, the inquiring individual is then afforded the option of attempting to establish contact with the target individual. In more specific embodiments, both the inquiring individual's vehicle and the target individual's vehicle are equipped with means for transmitting and receiving at least audio information via the Internet. The inquiring individual transmits to the central location a request to contact the target individual, preferably by audio means such as a telephonic menu. The target individual then receives an appropriate notification from the central location indicating that the inquiring individual wishes to establish contact with the target individual.

In specific embodiments, the central location provides an audio and/or textual message, rather than a visual message, in order to ensure that the target individual does not become distracted while driving. In very specific embodiments, the target inquiring individual can be advised that visual information is available once the vehicle is parked and no longer moving. The target individual can then stop the vehicle and access one or more of the use's data files in a manner similar to that described above. Alternatively, the target individual is afforded the option of forwarding the inquiring individual's data files to a third party for visual evaluation by the third party. The third party can then provide the target individual with a verbal report on the inquiring individual's appearance as well as on the content of other of the inquiring individual's data files. If the target individual is interested in being contacted by the inquiring individual, then the target individual can proceed in a manner similar to that described above, preferably by use of non-visual means such as providing responses to a telephone menu.

Further embodiments of the inventive method are useful when the inquiring individual and the target individual are in separate locations and are not in direct visual contact. In these embodiments, the inquiring individual first accesses a third party (an individual, a commercial establishment, etc.) over the Internet. The third party is in possession of a camera or other device capable of transmitting a video stream over the Internet. The inquiring individual then makes use of the third party's camera to identify a target individual of interest in a manner similar to that described above. If the target individual is a member of the inquiring individual's organization, then the inquiring individual can attempt to establish contact remotely via the third party's camera. In a particular embodiment, the third party is compensated for affording the inquiring individual the use of the third party's camera. In other particular embodiments, particularly useful when the inquiring individual and the target individual are located in different countries and speak different languages, the third party functions as a translator. Alternatively, the inquiring individual and/or the target individual can access independent translators to facilitate communication.

The foregoing particular embodiments make use of the central location to relay data and facilitate communication between the inquiring individual and the target individual. Alternative embodiments allow the inquiring individual to establish contact with the target individual by means of dedicated devices without use of the central location. In such embodiments, the inquiring individual and the target individual patronize an establishment, such as a nightclub, bar, or the like, which provides each of them with a paging device that preferably includes ranging and locating means. The paging device, in very particular embodiments, also includes means for downloading data supplied by the inquiring individual and/or target individual, such as a CD-ROM drive, and means for transmitting such data. The inquiring individual visually identifies a target individual of interest, determines the relative location of the target individual using the ranging and locating means, and, using the paging device, transmits a signal to the target individual's paging device. Preferably, the signal includes an identifying indicium, such as a code number or an identified frequency specific to the inquiring individual's paging device, to ensure that any data transmitted by the target individual is transmitted only to the inquiring individual. If the target individual desires to establish contact with the inquiring individual, she/he transmits a signal to the inquiring individual authorizing the inquiring individual to transmit one or more data files previously downloaded into the paging device. The target individual then reviews the transmitted data and determines whether or not to continue with the communication, in a manner similar to that described above.

Additional embodiments of the inventive method include both GPS location and the use of separate paging devices. In such embodiments, the inquiring individual identifies a target individual by determining his/her GPS location, as described above, and initiates contact with the target individual over the Internet. Once initial contact has been established, however, the inquiring individual and the target individual exchange data via paging devices, rather than through the central location.

A system for implementing a remote dating method according to the invention preferably includes at least the following: a ranging element; a location-determining element; and an element for transmitting information to a central location and receiving information from the central location. Several of these elements can be combined or integrated into a single unit.

A first specified embodiment of the inventive apparatus includes an ocular ranging device, in particular a cross-hairs element and an element that measures the positions of the inquiring individual's eyes and uses these measurements to determine the distance to the target (e.g., by triangulation); an integrated data processing and transceiving unit that includes (a) a GPS location device; (b) a wide-area network accessing element including (12) a processor provided with appropriate software and (2) a modem; (c) a communication device, such as a cellular telephonic device, connected to the processor via the modem; (d) an input device such as a keypad; and (e) a display element, in particular including an HUD, and also preferably including an earphone or other element for providing audio information. The ranging element, the HUD and the earphone can be part of a headset which is in turn connected to the wide-area network accessing element.

Referring to FIGS. 12A-C, an embodiment of a system for implementing a remote dating method of the invention includes a headset 1210 having a frame 1212 and ear pieces 1214. The aspects of the embodiment may also be applied to other situation where one or more targets are moving. Affixed to frame 1212 are earphone 1216, HUD 1218 having a cross-hairs element 1220, sensors 1222 for determining the positions of the eyes of an inquiring individual wearing the headset 1210, and direction determining element 1223 (such as an electronic compass). Earphone 1216, HUD 1218, sensors 1222 and direction determination element 1223 are in electrical communication via cord 1224 with integrated processing/transceiving unit 1226, which preferably is carried or worn by the inquiring individual. Unit 1226 includes a GPS location determination element 1228 (in particular embodiments in electrical communication with HUD 1218 to enable display of GPS coordinates on the HUD), a processing element 1230, preferably including a microprocessor and appropriate software and preferably in electrical communication with HUD 1218 to enable display of data files and other information, a communication element 1232 such as a cellular telephonic element, a keypad 1234 in electrical connection with processing element 1230 and communication element 1232, and optionally a trackball 1236 for positioning a cursor (not shown) displayed on HUD 1218 to enable the inquiring individual to select one or more menu items viewed on the HUD.

Preferably, both the inquiring individual and the target individual are equipped with devices 1210.

In practicing a method of the invention using device 1210, an inquiring individual sight a target individual uses the cross-hairs element 1220. Sensors 1222 determine the position of the inquiring individual's eyes while the inquiring individual is observing the target individual and provide the ocular position information to processing element 1230. Element 1223 determines the orientation of the inquiring individual. Processing element 1230 then determines the distance from the inquiring individual to the target individual. GPS determination element 1228 provides the inquiring individual's location. The inquiring individual's location and orientation, combined with the distance from the inquiring individual to the target individual, then are input to processing element 1230 to determine the location of the target individual. This location is transmitted to the remote dating service's central location (not shown) using communication. element 1232.

The central location then contacts the target individual, who in specific embodiments is also using an apparatus 1210. The signal from the central location is displayed on the target individual's HUD and/or provided via earphone 1216. In specific embodiments, the target individual provides a positive or negative response using keyboard 1234. In other specific embodiments, a menu is displayed on HUD 1218, and the target individual selects the appropriate response using keyboard 1234 and/or trackball 1236. Following a positive response, access to the inquiring individual's data file(s) is provided to the target individual, in specific embodiments via an appropriate menu displayed on HUD 1218. The target individual can specify one or more of the inquiring individual's data files of interest, again using keyboard 1234 and/or trackball 1236. Data files containing text, photographic and/or video information are displayed on HUD 1218, while audio information is conveyed to the target individual via earphone 1216. Subsequently, the target individual provides further negative or positive responses to the inquiring individual using keyboard 1234 and/or trackball 1236 in a manner similar to that previously described.

Referring to FIG. 13, an alternative headset 1340 includes an infrared pointer device 1342 in place of the sensors 1222 of the previous embodiment shown in FIG. 2C. Infrared pointer device 1342 emits an infrared beam that is reflected off the target individual and provides a direct measurement of the distance between the target individual and the inquiring individual. This measurement, together with the orientation of the inquiring individual as determined by element 1223, is provided to processing element and used to determine the location of the target individual in a manner similar to that discussed above.

The inventive method has been described primarily in the context of facilitating social interactions. However, alternative embodiments of the invention are more generally applicable to situations that rely on the location of a target individual and the acquisition of information pertaining to the tan-let individual. Thus for example, an alternative embodiment of the inventive method is useful as a security system. In such an embodiment, the inquiring individual identifies (visually or by other means) a target individual, for example in a public place such as a bus stop, restaurant, market or other location. After the target individual is identified, his/her location is determined and the location is provided to the central location, as described previously. In specific embodiments, the target individual bears indicia indicating membership in a particular organization, while in other embodiments; recognition software is utilized in order to identify the target individual. The central location then searches for one or more data files pertaining to the target individual. In specific embodiments, the central location searches for one or more data files that contain information indicating whether or not the target individual is authorized to be present in his/her present location, or is prohibited from being present in such location; whether or not the target individual is a known member of a criminal or terrorist organization or is otherwise wanted by a government authority; or other information.

Thus, for example, a security officer or concerned citizen can identify a target individual and attempt to determine whether the target individual is wanted by a government authority or otherwise potentially constitutes a threat to public security.

According to additional embodiments of the inventive method, an inquiring individual identifies (visually or by other means) a target individual and establishes contact as described herein. After establishing contact, the inquiring individual invites the target individual to an on-line video viewing, as described in U.S. patent application Ser. No. 12/070,715, incorporated herein by reference. An example of such post-contact on-line video viewing is illustrated in FIG. 6 (corresponding to FIG. 1 of the '715 application that priority is claimed to and was in corporate by reference).

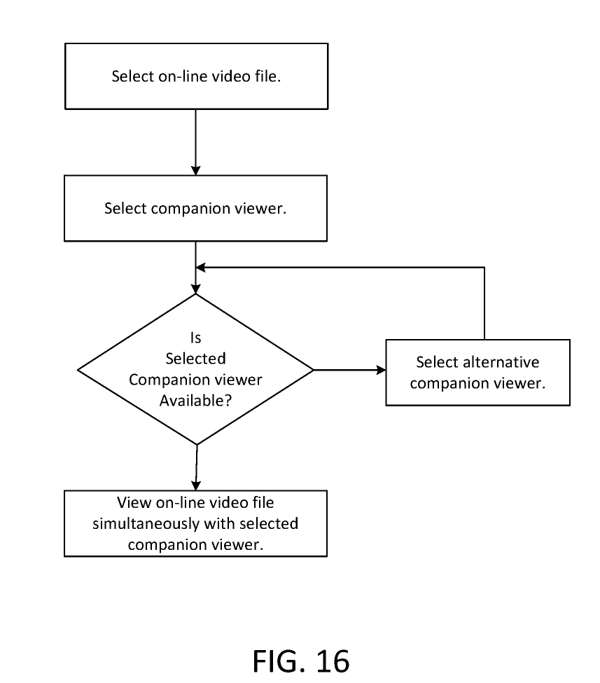

In particular embodiments, a remote dating organization to which the inquiring individual and the target individual belong also promotes simultaneous on-line viewing of video files by two or more of its members, as described in the '715 application. Thus, the inquiring individual simply selects the target individual as his/her companion viewer. In alternative embodiments, the inquiring individual is a member of a separate organization that promotes simultaneous on-line viewing of video files by two or more of its members. The inquiring individual invites the target individual to join the latter organization and submit her/his name for listing with some or all of the available video files offered for viewing by the latter organization. Once the target individual does so, the inquiring individual then selects the target individual as his/her companion viewer for viewing a selected video file. In various specific embodiments, the inquiring individual first proposes a video tile for viewing, then selects that video file at the time he/she selects the target individual as the companion viewer as shown in FIG. 16. In other specific embodiments, the target individual suggests the video file for viewing.

Co-ordinated on-line video viewing by the inquiring and target individuals affords additional advantages. The communication between individuals may also be beneficial to other areas as proximity communication is herein described. A target individual may be receptive to further interaction with the inquiring individual, yet be reluctant initially to do so in person. Co-ordinated on-line video viewing allows the target individual to share a video-viewing experience with the inquiring individual without the necessity for in-person interaction (i.e., go on a “virtual movie date”), affording the target individual an added measure of security until the target individual becomes comfortable with further interaction with the inquiring individual, and also affords additional time for background research or other investigations of the inquiring individual by the target individual.

Furthermore, in the event that the target individual (or the inquiring individual) is actually a cast member, director, writer, reviewer, etc. of an on-line video, embodiments of the invention that facilitate coordinated on-line viewing provide an additional desirable option for interaction between the inquiring and target individuals.

Described is a system for facilitating in-person interaction between a first user and a second user of a massively multi-user virtual environment (“MMVE”) where the first user utilizes a first user avatar and the second user utilizes a second user avatar. Avatars as herein described may be applied to additional online visualization systems. The system may include an input module, a comparator in signal communication with the input module, a determination module in signal communication with both the input module and comparator, and an output module in signal communication with the determination module. The input module may be configured to receive a first identification criteria corresponding to the first user and a second identification criteria corresponding to the second user and create a first user data signal and a second user data signal corresponding to the first identification criteria and a second identification criteria, respectively. The comparator may be configured to receive the first user data signal and a second user data signal, compare the first identification criteria to the second identification criteria, determine if the comparison of the first identification criteria to the second identification criteria satisfies a predetermined condition, and create a comparator signal that represents the result of the comparison of the first identification criteria to the second identification criteria. The determination module may be configured to create a query signal where the query signal includes a query to both the first user and the second user to determine if both the first user and the second user have an interest for an in-person interaction. The output module may be configured to transmit the query signal to both the first user and a second user to determine if both the first user and the second user have an interest for an in-person interaction.

The input module may be also configured to receive a response to the query signal from both the first user and second user. The determination module may be also configured to determine whether the first user and the second user have an interest for an in-person interaction. Moreover, the output module may be also configured to transmit contact information to both the first user and second user if both the first user and second user have an interest for an in-person interaction.

In operation, the system performs a method that may include determining a first identification criteria corresponding to the first user, determining a second identification criteria corresponding to the second user, comparing the first identification criteria to the second identification criteria, and determining if the comparison of the first identification criteria to the second identification criteria satisfies a predetermined condition. The method may also include transmitting a query to both the first user and a second user to determine if both the first user and the second user have an interest for an in-person interaction, receiving a response to query from both the first user and second user, determining whether the first user and the second user have an interest for an in-person interaction, and transmitting contact information to both the first user and second user if both the first user and second user have an interest for an in-person interaction.

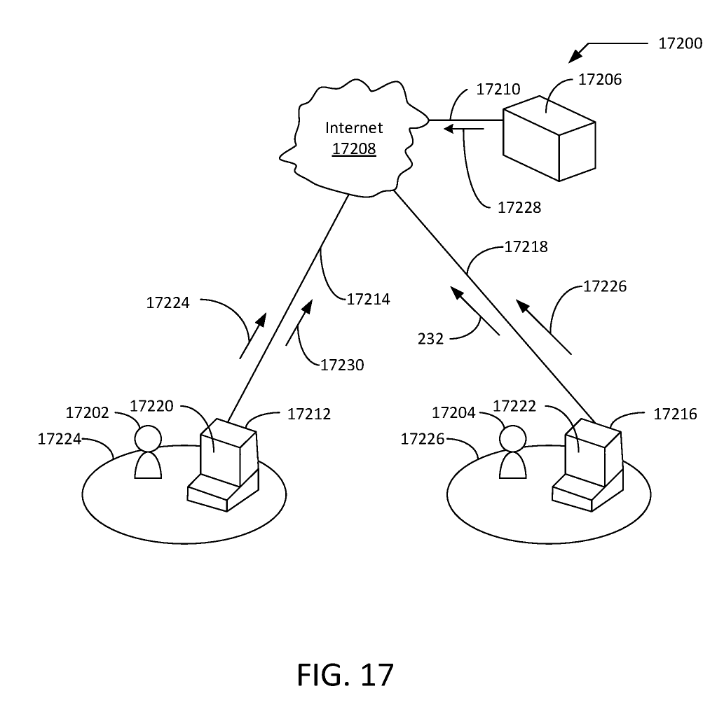

Turning to FIG. 17, a system diagram of an example of an implementation of system 200 for facilitating in-person interaction between MMVE users 17202 and 17204 is shown in accordance with the invention. The system 17200 may be located within a server 17206, or bank of servers (not shown) or in signal communication with server 17206. The first user 17202 and second user 17204 may access server 17206 via a computer network such as, for example, the Internet 17208. In this example, the server 17206 may be in signal communication with the Internet 17208 via signal path 17210. The first user 17202 may utilize a first online device 17212 that is in signal communication with the Internet 17208 via signal path 17214. Similarly, the second user 17204 may utilize a second online device 17216 that is in signal communication with the Internet 17208 via signal path 17218. The first online device 17212 may include a first online device display 17220 and the second online device 17216 may include a second online device display 17222. The first user 17202 and first online device 17212 may be located at a first user location 17224 and the second user 17204 and second online device 17216 may be located at a second user location 17226.

It is appreciated by those skilled in the art that the circuits, components, modules, and/or devices of the telepresence system are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying digital formats without passing through a direct electromagnetic connection.

It is additionally appreciated by those skilled in the art that while only two users are shown in FIGS. 17, 19, 20, and 21 and described through most of this disclosure, this has been done for the convenience of describing the invention with the understanding that the invention functions and is completely applicable to multiple users and their corresponding avatars (i.e., a third user, fourth user, fifth user and corresponding third, fourth, firth avatar as so forth). The number of users and avatars being limited by the limitation of the MMVE and corresponding hardware running/hosting the MMVE. Throughout this specification the description may equally be viewed as a first user 17202 and at least second user 17204.

In this example, the server 17206 (or servers) generates and/or hosts the MMVE, which may be a MMOG. The first user 17202 and second user 17204 may access the MMVE on the server 17206 via the Internet 17208. The first user 17202 and second user 17204 may access the Internet 17208 via the first online device 17212 and second online device 17216 via signal paths 17214 and 17218, respectively. Each online device 17212 or 17216 may be a personal computer (both portable and non-portable), a computer tablet (such as, for example, an iPad®, Android® based tablet, or Microsoft® based tablet), a personal digital assistant (“PDA”), or smartphone (such as, for example, an iPhone®, Android® based smartphone, or Microsoft® based smartphone), game console (such as, for example, PSP®, Playstation® 3, Xbox® 360, Nintendo DS, PS Vita, and Wii®) or any other equivalent device capable of accessing the Internet 17208. It is appreciated by those skilled in the art that while only two users 17202 and 17204 and online devices 17212 and 17216 are shown in FIG. 2, the MMVE may support thousands of users with corresponding thousands of online devices.

As an example of operation, the first user 17202 may log on to the MMVE on the server 17206 via the first online device 17212. The first user 17202 may accomplish this by logging on to a website or other online portal (not shown) hosted by the server 17206 that appears on the first online device display 17220. Similarly, the second user 17204 may log on to the MMVE on the server 17206 via the second online device 17216. The second user 17204 may accomplish this by logging on to a website or other online portal (not shown) hosted by the server 17206 that appears on the second online device display 17222. Once the first online device 17212 is logged on to the server 17206, the first online device 17212 communicates with the sever 17206 sending and receiving data signals back and forth to the server 17206 via signal path 17214, Internet 17208, and signal path 17210. These data signals allow the first user 17202 to interact in the MMVE on the server 17206. Similarly, once the second online device 17216 is logged on to the server 17206, the second online device 17216 communicates with the sever 17206 sending and receiving data signals back and forth to the server 17206 via signal path 17218, Internet 17208, and signal path 17210. These data signals allow the second user 17204 to interact in the MMVE on the server 17206.

Specifically, once the first user 17202 logs on to the MMVE on the server 17206 with the first online device 17212, the first online device 17212 may send a first user initialization signal 17227 to the server 17206 via signal path 17214, Internet 17208, and signal path 17210. The first user initialization signal 17227 may include information such as first identification criteria about the first user 17202 and the first online device 17212. This first identification criterion may include first user 17202 preferences for use in the MMVE, performance, capabilities, software information, and other technical information about the first online device 17212 and first online device display 17220, and information about the first user location 17224. Once the system 17200 in the server 17206 receives the first user initialization signal 17227, the system 17200 determines the first identification criteria for the first user 17202.

Similarly, once the second user 17204 logs on to the MMVE on the server 17206 with the second online device 17216, the second online device 17216 may send a second user initialization signal 17228 to the server 17206 via signal path 17218, Internet 17208, and signal path 17210. The second user initialization signal 17228 may include information such as second identification criteria about the second user 17204 and the second online device 17216. This second identification criteria may include second user 17204 preferences for use in the MMVE, performance, capabilities, software information, and other technical information about the second online device 17216 and second online device display 17222, and information about the second user location 17226. Once the system 17200 in the server 17206 receives the second user initialization signal 17228, the system 200 determines the second identification criteria for the second user 17204.

The first identification criteria and second identification criteria may both include preferences that are pre-determined by the first user 17202 and second user 17204, respectively. These pre-determined preferences may include user preferences related to politics, religion, gender, age, ethnicity, race, academics, interests, location of other users, and other social preferences.

Alternatively, the first user initialization signal 17227 and second user initialization signal 228 may only include logon, initialization, and location information for the first user 17202 and second user 17204, respectively. In this example, the first user 17202 and second user 17204 have already logged on to the system 17200 previously and have initialized accounts on the system 17200. This initialization included providing the system 17200 with identification criteria including the pre-determined preferences for the respective user. The pre-determined preferences may have been stored in a memory (not shown) corresponding to the system 17200. Once the first user 17202 and second user 17204 log into the server 17206, the system 17200 recognizes the respective users 17202 and 17204 and access their corresponding pre-determined preferences from the memory.

Once the system 17200 determines the first identification criteria for the first user 17202 and the second identification criteria for the second user 17204, the system 17200 then compares the first identification criteria to the second identification criteria and determines if the comparison of the first identification criteria to the second identification criteria satisfies a pre-determined condition. The pre-determined condition may be that both the first user 17202 and second user 17204 are located within a pre-determined distance of each other, share a common political view, religion, common interest, ethnicity, have a common interest in gender and/or age, etc.

If the comparison of the first identification criteria to the second identification criteria satisfies the pre-determined condition, the system 17200 may allow the first user 17202 and second user 17204 to interact with each other virtually within a simulated environment (i.e., scene) of the MMVE. The first user 17202 may utilize a first avatar (not shown) and the second user 17204 may utilize a second avatar (not shown). As such, the first user 17202 may interact with second user 17204 in a scene via the first avatar and second avatar, respectfully.

Additionally, the first identification criteria and second identification criteria may and provide information that corresponds to the first user 17202 and second user 17204. An example of this system 17200 provided information may include information regarding the governmental laws or regulations related to each user. For example, if either the first user 17202, second user 17204, or both are minors, the system 17200 may include age identification that may limit or enable access to certain parts of the MMVE. Moreover, if first user 17202, second user 17204, or both are located in geographic locations that have certain legal restrictions either by governmental laws or regulations, or commercial limitations such as, trademark, copyright, patent, or contractual limitations, the system 17200 may limit access to MMVE functions or scenes that properly comply with this limitations.

This approach helps segregate the users of the MMVE to reduce the computational loads in running the MMVE for the server 17206 or servers. Generally, as the number of concurrent users increases, the information that must be tracked and generated by the server 206 (or servers) increases geometrically. The positions of each avatar with respect to any particular portion of the scene, and with respect to other avatars, must be calculated and displayed to the different users. At some point, the computational load becomes excessive.

Segregation of the MMVE is an example of an approach to help resolve this difficulty. In this example, some MMVE's divide users into two or more groups. When the number of avatars present at a given scene meets a selected value, the MMVE generates an identical duplicate of the scene. Subsequent avatars begin to populate the duplicate of the scene so generated. The process is repeated as needed, depending on the number of concurrent users who desire to enter each scene. However, known segregation techniques only segregate based on the numbers of users in a given scene and do not take into account the preferences or locations of the users. The system 17200 does take into account the preferences or locations of the users.

As an example, the system 17200 may include a scene generator (not shown) that generates a scene for the first user 17202 and second user 17204 based on the first identification criteria, second identification criteria, and the determination of whether the comparison of the first identification criteria to the second identification criteria satisfies a pre-determined condition. The generated scene from the scene generator may include the first avatar of the first user 17202, second avatar of the second user 17204, or both based on the determination of whether the comparison of the first identification criteria to the second identification criteria satisfies the pre-determined condition.

If the pre-determined condition is not satisfied, the scene generator may generate a first scene that includes the first avatar and second scene that includes the second avatar. As mentioned above regarding segregation, the first scene and second scene are identical duplicate scenes but in the first scene there will not be an avatar for the second user 17204 and in the second scene there will not be an avatar for the first user 17202. The first scene would be transmitted to the first online device 17212 via signal path 17210, Internet 17208, and signal path 17214 and the second scene would be transmitted to the second online device 17216 via signal path 17210, Internet 17208, and signal path 17218. The first scene would them be displayed on the first online device display 17220 and the second scene would be displayed on the second online device display 17222. As a result, the first user 17202 would see the first scene with his/her first avatar and possibly other avatars corresponding to different users, however, the first user 17202 would not see the second avatar corresponding to the second user 17204. Similarly, the second user 17204 would see the second scene with his/her second avatar and possibly other avatars corresponding to different users, however, the second user 17202 would not see the first avatar corresponding to the first user 17202. As such, the first user 17202 and second user 17204 will not be able to virtually interact in the scene.

An example of this situation may be where a first user 17202 has selected a specific scene but does not want to interact with people who have a specific political view such as, a fascist (which is a preference in his/her identification criteria). In this example, if the second user 17204 has selected the same scene but has also identified himself/herself as a fascist in his/her identification criteria, the system 17200 would filter requests such that the first avatar of the first user 17202 and second avatar of the second user 17204 would be inserted into different but identical copies of the mutually selected scene. This filtering would be limited to excluding the second user 17204 from being inserted into the same copy of the mutually selected scene in which the first user 17202 has been inserted and would not affect the population of the scene selected by the first user 17202 with avatars from other users that are not identified as fascists. The first user 17202 would then be capable of interacting virtually with these other users via their respective avatars.

If, instead, the pre-determined condition is satisfied, the scene generator may generate a scene that includes both the first avatar and second avatar within the scene. This scene would be transmitted to the first online device 17212 and second online device 17216 via signal paths 17201, the Internet 17208 and signal paths 17214 and 17218, respectively. The scene would then be displayed on the first online device display 17220 and second online device display 17222. In this example, the first user 17202 and second user 17204 may interact virtually with each other via their respective first user avatar and second user avatar.

Another example may be based on the respective locations of the users 17202 and 17204. This example may be independent of or in combination with the previous example. In this example, if the first user 17202 and second user 17204 have a first user location 17224 and second user location 17226 that are within the same geographic area or areas that are sufficiently close to each other as either pre-determined by the system 17200 or the users 17202 and 17204 themselves, the scene generator may generate a scene that includes both the first avatar and second avatar within the scene.

In this example, if first user location 17224 and second user location 17226 are not within the same geographic area or areas that are sufficiently close to each other as pre-determined by the system 17200 of the users 17202 and 17204, the scene generator may generate two different identical scenes (a first scene and a second scene) where the first scene corresponds to the first avatar and the second scene corresponds to the second avatar. In this situation, the first avatar of the first user 17202 will not be capable of interacting with the second avatar of the second user 17204.

The system 17200 may determine the location of the first user 17224 and location of the second user 17226 via numerous known techniques that may include using the Internet Protocol address of the first online device 17212 and the second online device 17216, utilizing GPS or other location information provided by the first online device 17212 and the second online device 17216 to the system 17200, utilizing techniques described in U.S. Pat. No. 6,154,172, titled “System and process for limiting distribution of information on a communication network based on geographic location,” issued Nov. 28, 2000, or other known location techniques.

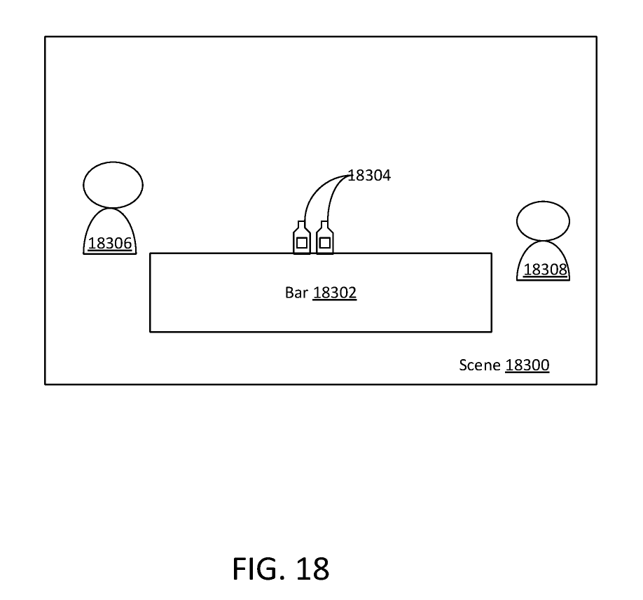

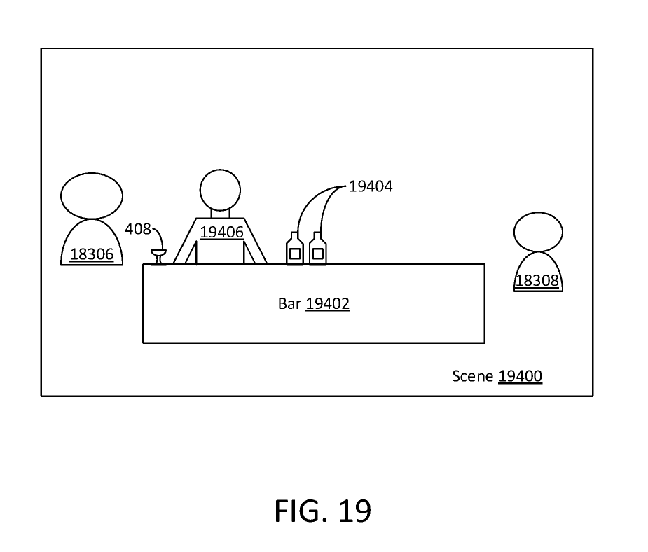

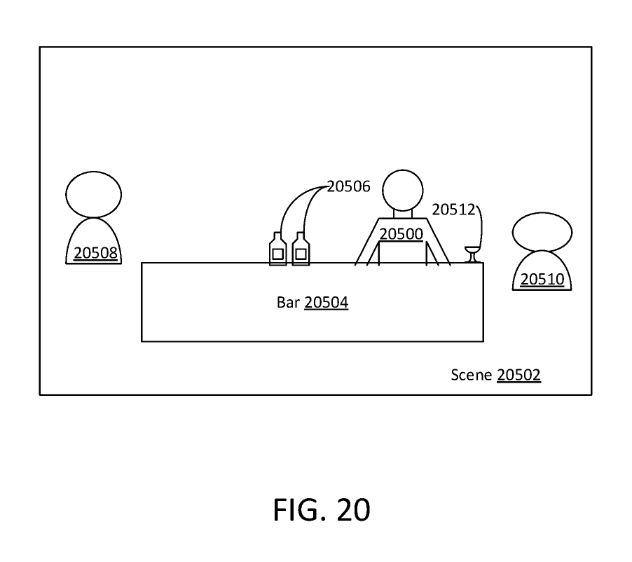

In FIGS. 18 through 23, show different screen shots of scenes generated by the scene generator of the system 17200 in accordance with the invention. In FIG. 18, a screen shot of an example of an implementation of a scene 18300 including a bar 18302, some bottles 18304 and two avatars of different users 18306 and 18308 is shown. The first user 17202 and second user 17204 are not shown in the scene. In FIG. 19, a screen shot of an example of an implementation of a new scene 19400 including the bar 19402, bottles 19404, and two avatars of different users 18306 and 18308 is shown. The difference between the scene 18300 and scene 19400 is that in scene 19400 of FIG. 20, a first avatar 19406 is shown with a glass 19408. In the example shown in FIG. 19, it is appreciated that first user 19202 entered the scene 19400 before the second user 17204 attempted to enter the scene 19400. If the pre-determined condition described above is not satisfied when the second user 19204 attempts to enter scene 19400, the scene generator will not allow the second user 17204 to enter the scene 19400. As such, the scene 19400 is limited to first avatar 19406 and the two avatars of different users 18306 and 18308. As a result, in FIG. 20, the second avatar 20500 is shown in a duplicate identical copy of scene 20400. In FIG. 20, a screen shot of an example of an implementation of a scene 20502 including a bar 20504, some bottles 20506 and two avatars of different users 20508 and 20510 is shown. The two avatars 20508 and 20510 are of two different users than the avatars 18306 and 18308. The difference between the scene 18502 and scene 19400 of FIG. 4 is that in scene 20502, of FIG. 20, the second avatar 20500 of the second user 17204 is shown with a glass 20512. In this example, the first avatar 19406 is not capable of virtually interacting with the second avatar 20500. As such, the system 17206 would transmit the scene 19400 to the first online device 17212, which would be displayed on the first online device 17220, and transmit the scene 20502 to the second online device 17216, which would be displayed on the second online device display 17222.

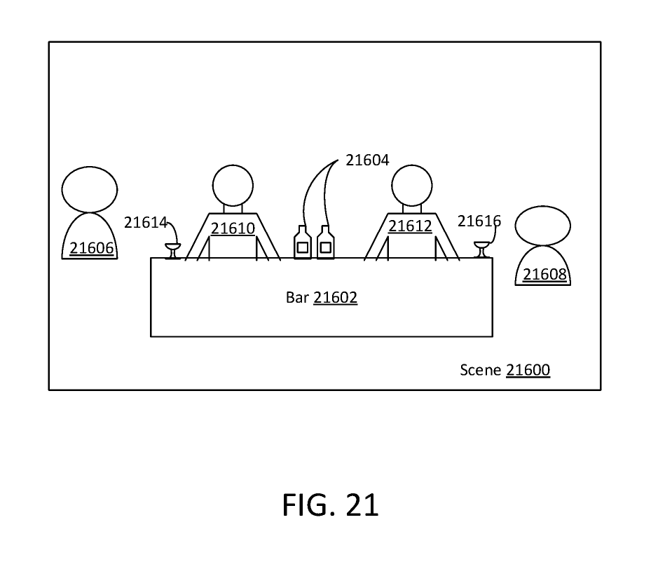

Turning to FIG. 21, a screen shot of an example of an implementation of another scene 21600 including a bar 21602, some bottles 21604 and two avatars of different users 21606 and 21608 is shown. The two avatars 21606 and 21608 may be the avatars 18306 and 18308 of the users shown in FIGS. 18 and 19, the avatars 20508 and 20510 of the users shown in FIG. 20, or the avatars of different users. The difference between the scene 21600 and scene 19400 of FIG. 19 and scene 20502 of FIG. 20 is that in scene 21600, of FIG. 21, both the first avatar 21610 of first user 17202 and second avatar 21612 of second user 17204 are shown in the same scene 21600 with corresponding glasses 21614 and 21616. In this example, the system 21206 would transmit the scene 21600 to both the first online device 17212, which would be displayed on the first online device 17220, and the second online device 17216, which would be displayed on the second online device display 17222.

Once the common scene 21600 has been generated by the scene generator, the first user 17202 and second user 17204 will have the ability to interact virtually via their respective avatars (i.e., via the first avatar 21610 and second avatar 21612, respectively).

As another example, the scene generator may also act to either preclude the generation of a certain scene or to modify an existing scene, both of which will prevent an avatar-to-avatar interaction, user-to-user interaction, and/or user-to-system interaction. In this example, if first user 17202 and second user 17204 desire to direct their respective avatars to go to a virtual casino in the MMVE with purpose of gambling real money, if either the first under 17202 or second user 17204 are not in a physical real world location where such gaming is lawfully allowed, the system 17200 may be configured to not allow any user, which is located in geographic location were this activity is illegal, to enter and/or interact with a scene that allows gambling real money. In furtherance of this example, the system 17200 may modify the scene for the user that is not allowed to gamble real money to a new hybrid scene that allows the user that may legally gamble to virtually gamble for real money in the scene while only allowing the user that cannot legally gamble to only gamble for fun and not money. In this example, the scene generator allows, limits, or modifies how one or more users and/or their avatars may interact with each other and/or the system 17200 in general based on the user's geographic locations and applications of applicable governmental laws or regulations.

In another example, if first user 17202 and second user 17204 desire to direct their respective avatars to go to a virtual cinema in the MMVE with purpose of viewing a motion picture, if either the first under 17202 or second user 17204 are not in a physical real world location where the movie have been released, the system 17200 may be configured to not allow any user, which is located in geographic location were the movie has not been released, to enter and/or interact with a scene that allows viewing of the movie. Turning back to FIG. 17, once the first avatar 21610 and second avatar 21612 interact virtually, a determination module in the system 17200 will note that the first user 17202 and second user 17204 have interacted virtually via their respective avatars 21610 and 21612. The system 17200 will then send a query signal 17229 to both the first online device 17212 and second device 17216 that will query the first user 17202 and the second user 17204 as to whether they would be interested in receiving information that would facilitate a potential in-person interaction between the first user 17202 and second user 17204. In response to the query, the first user 17202 will send a response via a first response signal 17230 and the second user 17204 will send a response via a second response signal 17232. The first response signal 17230 is sent from the first online device 17212 to the system 17200 via signal paths 17214, Internet 17208 and signal path 17210. Similarly, the second response signal 17232 is sent from the second online device 17216 to the system 17200 via signal paths 17218, Internet 17208 and signal path 17210. The system 17200 receives the first response signal 17230 and second response signal 17232 and, in response, determines whether the first user 17202 and the second user 17204 have an interest for an in-person interaction. If the system 17200 determines that the first user 17202 and the second user 17204 have an interest for an in-person interaction, the system 17200 transmits contact information to both the first online device 17212 of the first user 17202 and second online device 17216 of the second user 17204.

This contact information may include names and addresses of locations suitable for in-person meetings, including without limitation restaurants, bars, nightclubs, theaters, concert halls, parks, beaches, shopping centers, health clubs, sports stadiums, etc. Additionally, the system 17200 may allow persons or entities, such as businesses (generally referred to as advertisers), to register with the system 17200 in a way that allows the system 17200 to provide the first user 17202 and/or second user 17204 with advertisements, discount coupons (virtual or downloadable) or other premiums to motivate them to patronize one or more of the registered business establishments identified by the system 17200.

In regards to advertisement, the system 17200 may enable advertisers to focus their advertising efforts to users whose physical location, virtual location (i.e., location of the user's avatar within the MMVE), and/or preferences are compatible with the advertiser's desired advertising. In general, the system 17200 enables or limits communications (such as advertising or other content transmission) to the user, directly and/or via one or more avatars in the MMVE, based on the physical location(s), virtual location(s) (e.g., location(s) of a user's and/or another's avatar in the MMVE), and/or preferences of the user.

Additionally, the system 17200 may be configured to allow “Groupon-like” advertisement. In this example, the system 17200 is configured to allow an advertiser to send advertisement to a group of users if the corresponding there is a pre-determined threshold number of avatars within a specified virtual location and/or a pre-determined threshold number of users within a specified geographical location. Both the pre-determined threshold number of avatars and pre-determined threshold number of users may be defined by the advertiser. Moreover, in this example, the offer related to the advertisement sent by the advertiser may be limited and, therefore, not valid unless a threshold number of users, via their corresponding avatars, accepts the offer.

In another example of advertising, if a shoe store with a single location in a city purchases (from the provider and/or operator of the MMVE) advertising on a pay per click basis, the advertising will appear in the MMVE in virtual “proximity” to a user's avatar (for example, on a virtual billboard or on the clothing of an avatar in the MMVE scene that includes the user's avatar) and/or on the online device of a user. The system 17200 may be configured limit the advertising to users that are physically close in proximity to the shoe store so that the shoe store does not have to pay for advertising clicks that are not likely to result in sales because the user engaging the advertising is located far from the shoe store (e.g., in another city or country). This shore store and/or system 17200 may set a pre-determined threshold distance to trigger the transmission of advertising to a potential user. That pre-determined threshold may be, for example, 10 kilometers.

In a further example of advertising, the system 17200 may be configured to provide to a plurality of users who are communicating with each other via their respective avatars in the MMVE an advertisement, such as a coupon, to purchase goods or services at an establishment that is within predetermined distance from all of the subject users. For example, the system may be configured to provide to a two users who are conversing in a virtual concert hall lobby after a concert an electronic discount coupon and invitation to come to a Starbucks® bistro that is within a predetermined threshold distance from both users' physical locations to continue their conversation. The distance threshold may be, for example, 2 kilometers from each of the users. The system 17200 may also be configured to use other demographic data previously obtained to determine the type of advertising communication to present to the users. For example, continuing the example above, the system could be configured only to present the advertisement and invitation to come to the Starbucks® bistro if the users have registered within the MMVE as “single”, “interested in new relationships”, “coffee drinker”, etc.

These advertisements may be shown directly on the display of the online device of the user and/or virtually in scene of the MMVE. As an example, when the criteria are met for the avatars, a virtual billboard (or other similar virtual object) might appear in the virtual world scene in which the avatars are interacting with. Alternatively, or in combination, an advertisement and/or message may be sent directly to the user via the online device. This advertisement and/or message may appear as a pop-up window on the display of the online device, via a text message, via an email message, or other computer-related communication means.

Advertisements or other content may be displayed to a user via a virtual billboard (or other virtual object), or via other digital communication means (e.g., via the user's phone) based upon where the user's avatar is located in the MMVE, the type of activity the user or avatar is engaged in the MMVE, the user's MMVE personal profile, and/or a combination of some or all of the foregoing. For example, if the user's avatar is in a virtual furniture store, an advertisement for a real furniture store, or for another virtual furniture store may be displayed to the user via a virtual billboard or other virtual object in the MMVE or otherwise transmitted to the user.

In another example, the first user 17202 and second user 17204 may be members of a common organization, for example a social organization as described in U.S. patent application Ser. No. 11/998,679, titled “Remote Dating Method,” filed Nov. 30, 2007. In this example, the first user 17202 and second user 17204 may be placed in contact with each other using procedures similar to those described in U.S. patent application Ser. No. 11/998,679. Once the contact information is provided to the first user 17202 and second user 17204 according to the foregoing procedures, the two users 17202 and 17204 may then meet in-person at a desired location.

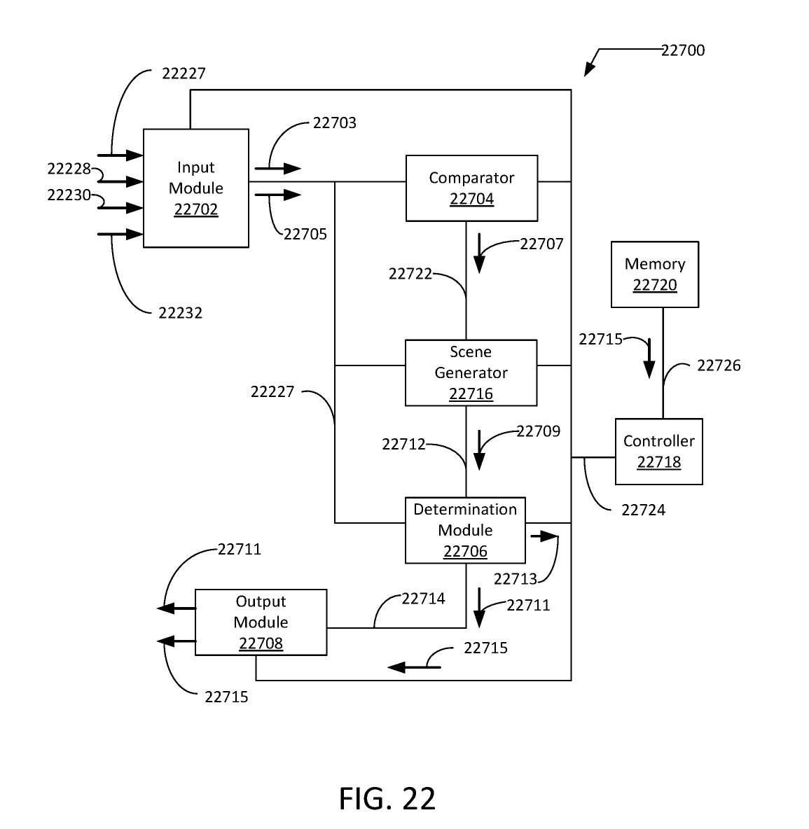

Turning to FIG. 22, a system diagram of an example of an implementation 22700 of the system 17200 shown in FIG. 17 is shown in accordance with the invention. The implementation 22700 may include an input module 22702, comparator 22704, determination module 22706, and output module 22708. The input module 22702 is in signal communication with the comparator 22704 and the determination module 22706 via signal path 22710. The determination module 706 may be in signal communication with the comparator 22704 and the output module 22708 via signal paths 22712 and 22714, respectively.

The implementation 22700 may also include a scene generator 22716, controller 22718, and memory 22720. The scene generator may be in signal communication with the input module 22702, comparator 22704 and determination module 22706 via signal paths 22710, 22722, and 22712, respectively. The controller 22718 may be in signal communication with the input module 22702, comparator 22704, scene generator 22716, determination module 22706, and output module 22708 via signal path 22724. The controller 22718 may be also in signal communication with the memory 22720 via signal path 22726.

In this example, the input module 22702 is configured to receive the first user initialization signal 22227 that includes the first identification criteria corresponding to the first user 22202 and the second user initialization signal 22228 that includes the second identification criteria corresponding to the second user 22204 and create a first user data signal 22703 and a second user data signal 22705 corresponding to the first identification criteria and a second identification criteria, respectively. The input module 22702 is also configured to send the first user data signal 22703 and a second user data signal 22705 to the comparator 22704.

The comparator 22704 is configured to receive the first user data signal 22703 and a second user data signal 22705 from the input module and compare the first identification criteria to the second identification criteria. The comparator 22704 is also configured to determine if the comparison of the first identification criteria to the second identification criteria satisfies a predetermined condition, and, in response, create a comparator signal 22707 that represents the result of the comparison of the first identification criteria to the second identification criteria.

The scene generator 22716 is configured to create a scene in the system 22700 for the first avatar of the first user 17202, second avatar of the second user 22204, or both in response to receiving the comparator signal 22707 from the comparator 22704. The scene generator 22716 is also configured to create a scene signal 22709 that is passed to the determination module 22706 via signal path 22712.

The determination module 22706 is configured to receive the scene signal 22709 from the scene generator 22716 and, in response, determine if the has been any virtual interaction between the first avatar of the first user 17202 and second avatar of the second user 1717204. If there has been has been any virtual interaction between the first avatar of the first user 202 and second avatar of the second user 17204, the determination module 22706 is configured to create a query signal 22711 that includes a query to both the first user and the second user to determine if both the first user and the second user have an interest for an in-person interaction. The determination module 22706 is also configured to send the query signal 22711 to the output module 22708, via signal path 22714, and the output module 22708 is configured to transmit the query signal 22711 to both the first user 202 and a second user 204 to determine if both the first user 17202 and the second user 17204 have an interest for an in-person interaction.

In this example, the input module 22702 is also configured to receive a response to the query signal (i.e., first response signal 17230 and second response signal 17232) from both the first user 17202 and second user 17204. This response is passed from the input module 22702 to the determination module 22706 via signal path 22710. The determination module 22706 is also configured to determine whether the first user 17202 and the second user 17204 have an interest for an in-person interaction. If the determination module 22706 determines that the first user 17202 and the second user 17204 have an interest for an in-person interaction, the determination module 22706 is configured to send an in-person interaction signal 22713 to the controller 22718, via signal path 22724, requesting that contact information be sent to both first user 17202 and second user 17204.

The controller 22718 is configured to receive the in-person interaction signal 22713 and, in response, access contact information 22715 for both first user 17202 and second user 17204 from the memory 22720 via signal path 22726. The controller 22718 is also configured to send this contact information 22715 to the output module via signal path 22724. The output module 22708 is also configured to receive the contact information 22715 from the controller 22718 and, in response, transmit contact information 22715 to both the first user and second user if both the first user and second user have an interest for an in-person interaction. The controller 22718 may be a processor, microprocessor, digital signal processor (“DSP”), application specific integrated circuit (“ASIC”) or other similar device.

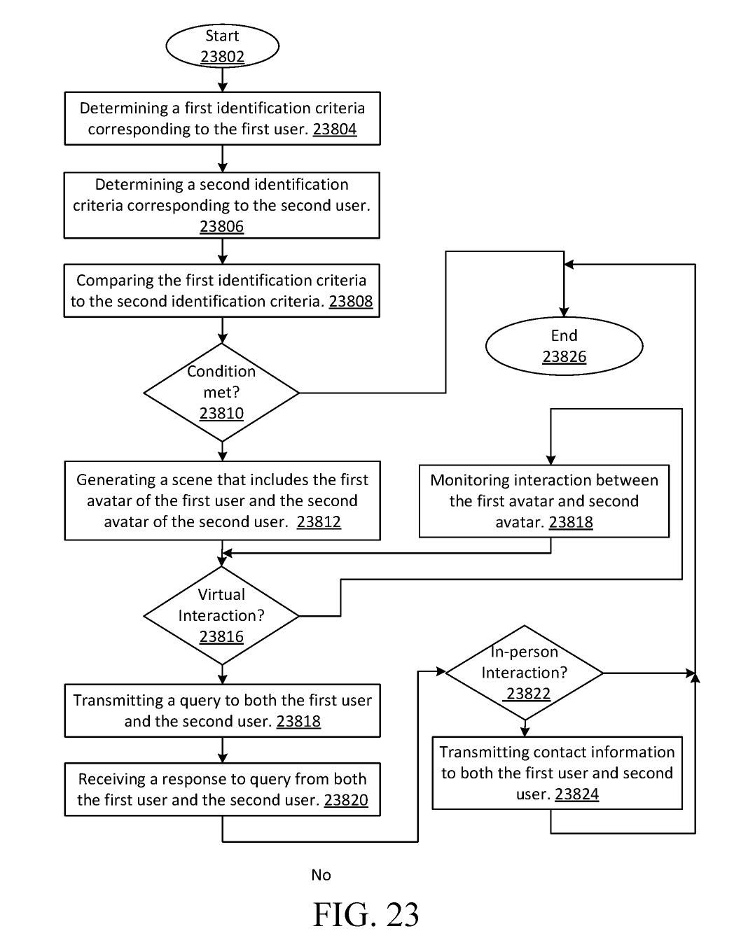

In FIG. 23, a flowchart 23800 of an example of an implementation of a method performed by the implementation 22700 is shown in accordance with the invention. The process starts 23802 and, in step 23804, the system determines a first identification criteria corresponding to the first user 17202. Similarly, in step 23806, the system determines a second identification criteria corresponding to the second user 17204. The system then compares the first identification criteria to the second identification criteria in step 23808. In decision step 23810, if the comparison of the first identification criteria to the second identification criteria satisfies a pre-determined condition, in step 23812, a scene is generated that includes the first avatar of the first user 17202 and the second avatar of the second user 17204. If the pre-determined condition is not met, two duplicate identical scenes are generated, one for the first avatar of the first user 17202 and the second one for the second avatar of the second user 17204. In this situation the first user and second user will not be able to interact virtually so the process ends 23814.

Returning to step 23812, the process continues to decision step 23816. If the first avatar and second avatar virtually interact, the system, in step 23818, transmits a query to both the first user and a second user to determine if both the first user and the second user have an interest for an in-person interaction. If the first avatar and second avatar do not virtually interact, the system continued to monitor the actions of the first avatar and second avatar in the generated scene to determine if they interact at a later time.

When the first user 17202 and second user 17204 receive the query from the system, they will decide if they want any in-person interaction with each other. Then they both send responses to the system. The system receives the responses to the query from both the first user 17202 and second user 17204 in step 23820. In decision step 23822, if the response to the query is that both the first user 17202 and second user 17204 desire in-person interaction, the system, in step 824, transmits contact information to both the first user 17202 and second user 17204 to facilitate in-person interaction. The process then ends 23826. If, instead, the response to the query, in decision step 23822, is that one of the first user 17202 and second user 17204 does not desire in-person interaction, the avatars continue to interact with each other but the system will not transmit contact information to either the first user 17202 or the second user 17204. The process then ends 23826.

As employed herein, the term “aggregate site” denotes a site on a network at which a plurality of displays are provided, with the displays being directed to the aggregate site from one or more sites on which performances are initially displayed, or are made available by link (e.g., via activation of a thumbnail, number, symbol or other abstract indicium associated with a service provider, such as a performer). In some preferred embodiments, such displays are associated with or contain links to the performances that meet the performance criterion or criteria, such that engagement of the link by clicking on the display will cause a user's web browser to connect with the performance that complies with the performance criterion or criteria or a link to the performance that meets the performance criterion or criteria. In some embodiments, the display of thumbnail displays of live performances or provider of service meeting one or more criteria, or iconic links to such performances, or iconic links to links to such performances can be aggregated to appear a grid-like display similar to “tube sites” that display thumbnail display links to recorded content.

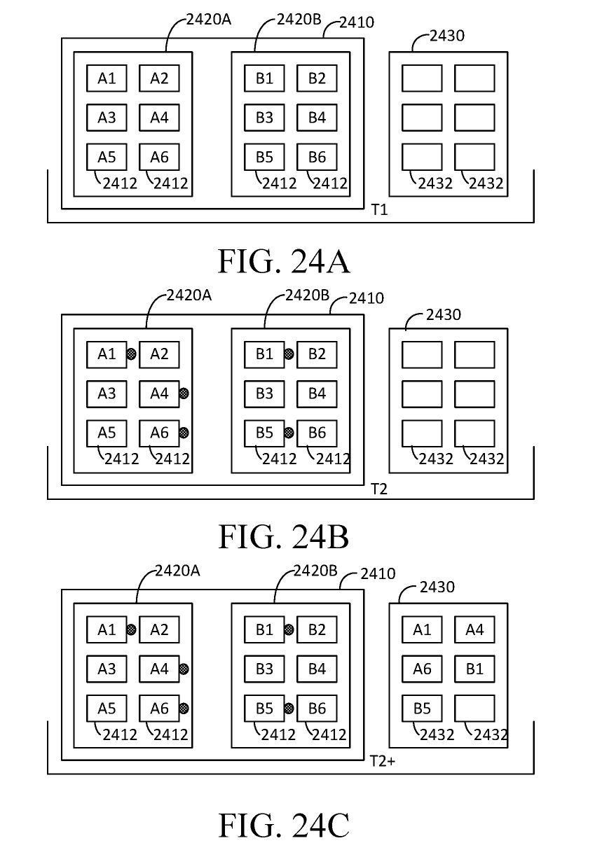

Referring to FIGS. 24A-C, display 2410 provides access to one or more performance sites offering multiple windows 2412 each featuring a thumbnail, number, symbol or other abstract indicium associated with a performer. As shown, performance sites 2420A and 2420B offer multiple windows featuring such indicia associated with performers A1-A6, B1-B6. At time T1, aggregate site 2430 initially displays a plurality of blank windows 2432 (see FIG. 24A).

A human observer of display 2410 selects one or more individual performers for viewing, and activates the thumbnail or other indicium associated with the selected performer(s) in order to view their performances. As illustrated, the human observer observes at time T2 that performers A1, A4, A6, B1 and B5 now meet a performance criterion. In particular embodiments, the performers are human females who have removed clothing sufficient to be considered topless, or nude, and thus to comply with the performance criterion of being topless or nude. In FIG. 24B, the human observer selects windows 2412 displaying performers A1, A4, A6, B1 and B5 engaged in performances compliant with the performance criterion (indicated by dots adjacent each selected window in the exemplary illustration of FIG. 24B, although such displays are optional). The human observer then establishes an aggregation link from the link associated with performances A1, A4, A6, B1 and B5, and provides the aggregation links so established to aggregate site 2430, such that each selected performer is displayed at time T2+ in an open window 2432 of aggregate site 2430 (FIG. 24C).

Aggregate site 2430 is made available to one or more human viewers over a network, such as the Internet or any other wide-area or local network. Thus, a human viewer of aggregate site 2430 is enabled to view only the desired compliant performances, i.e., the performances that meet the performance criterion, without having to search through non-compliant performances before locating a compliant performance. In the foregoing particular embodiments, the human viewer is thus enabled to view only those performers who are presently topless or nude.

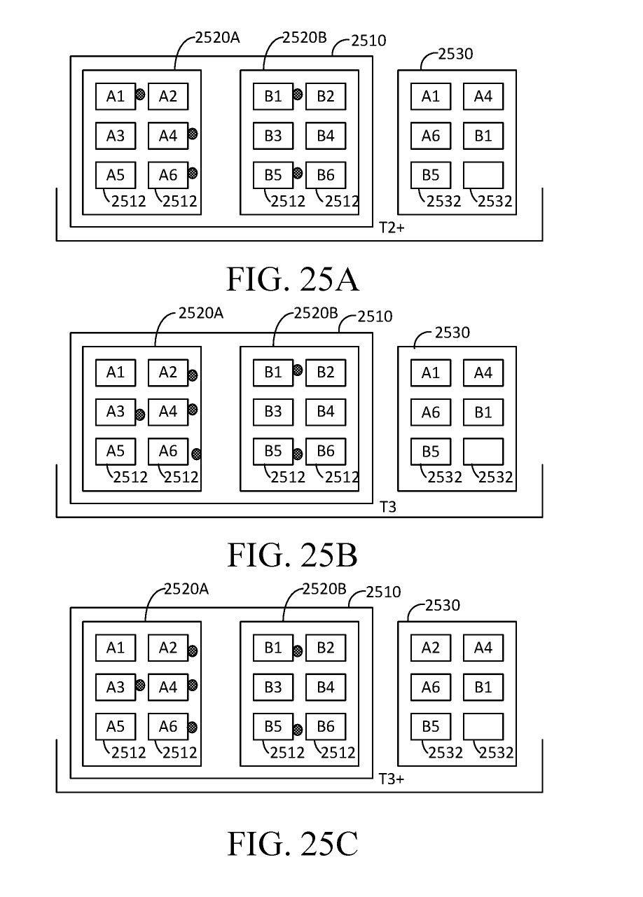

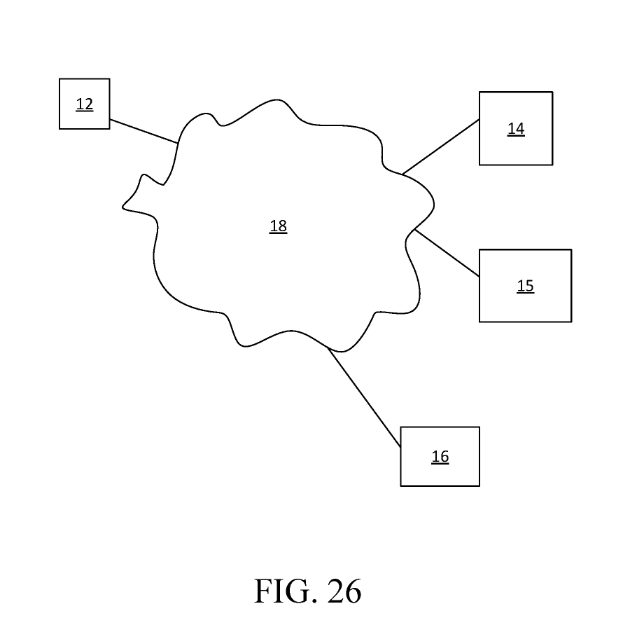

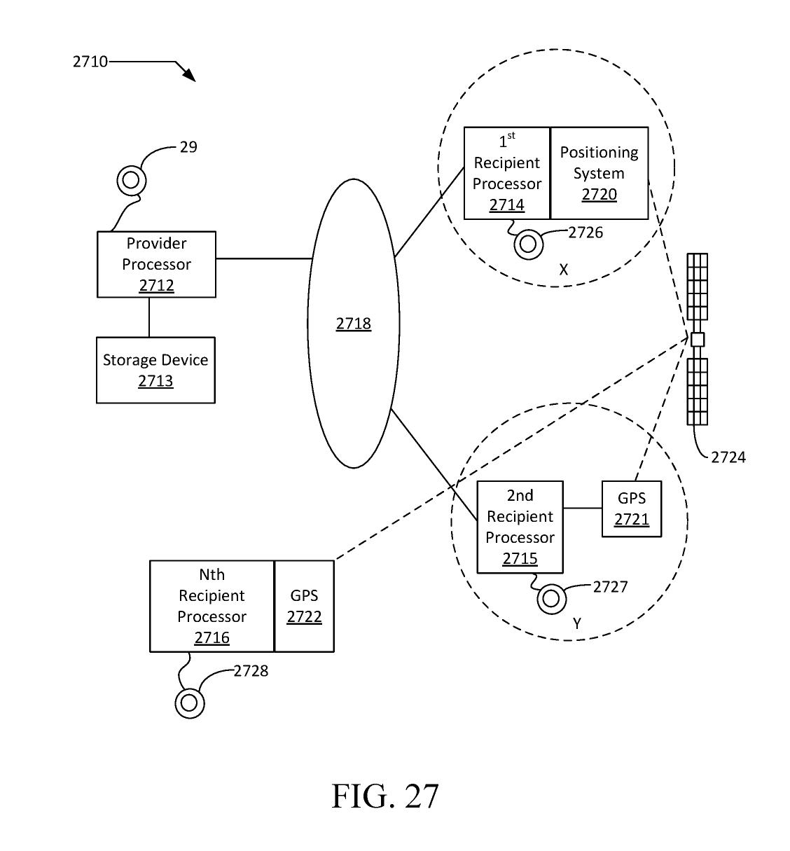

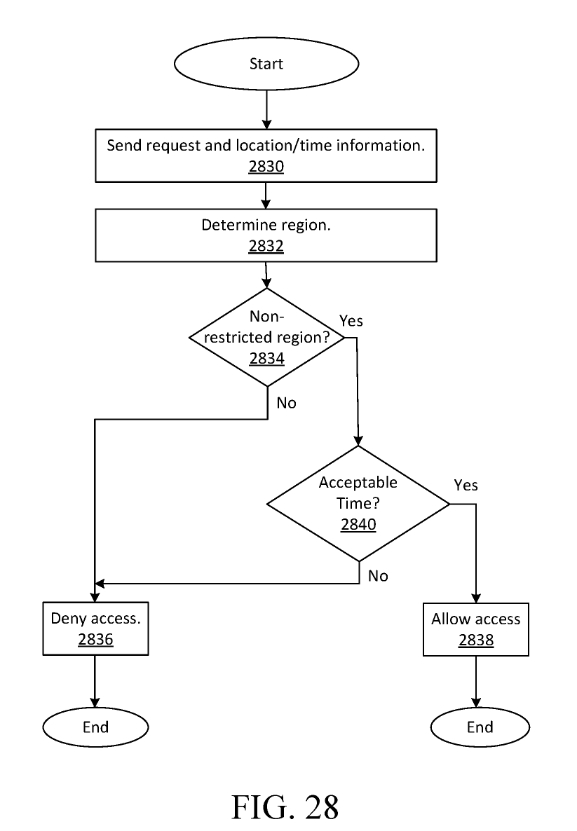

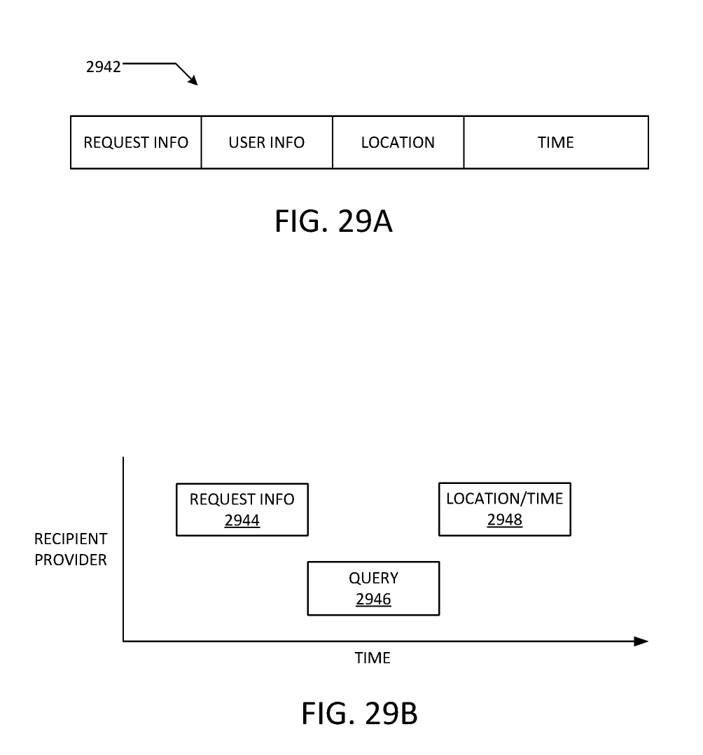

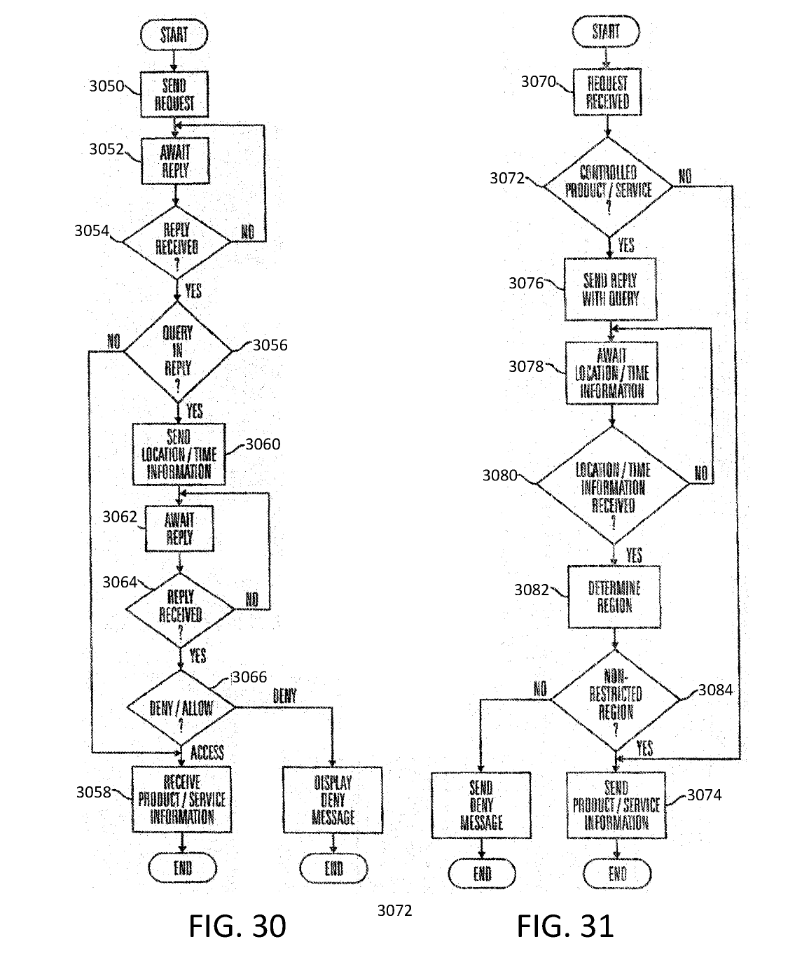

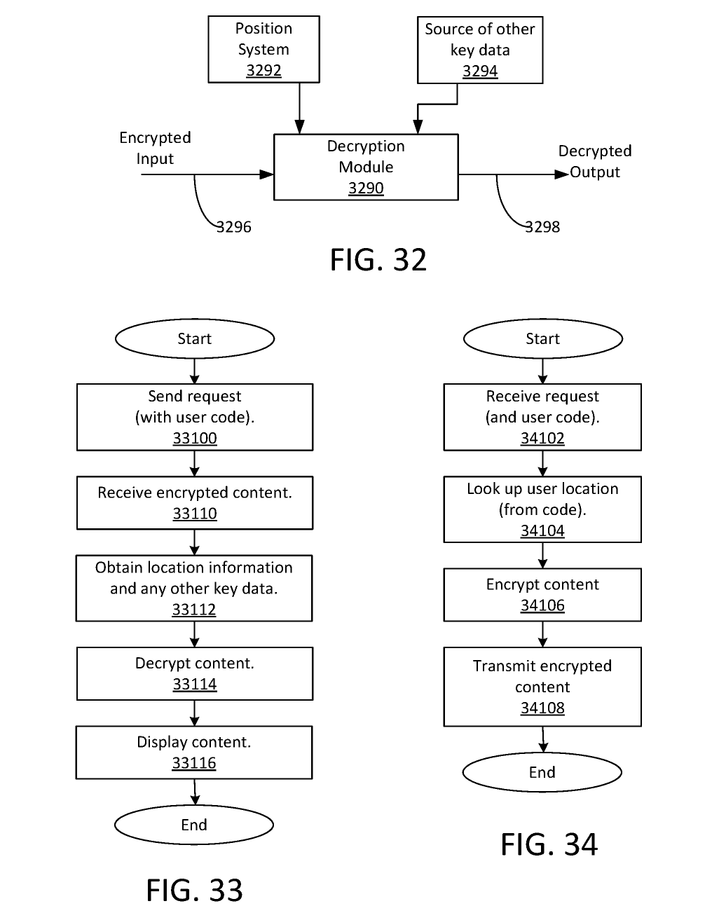

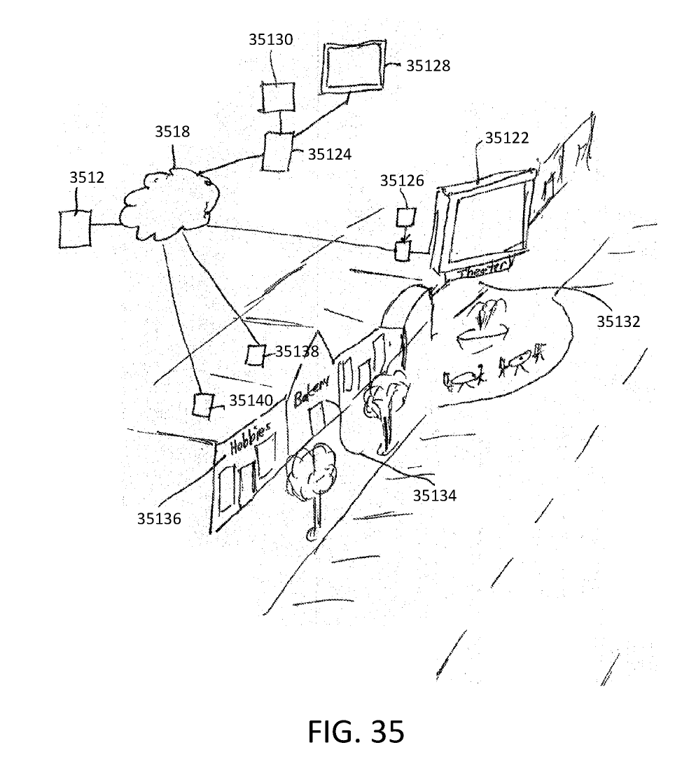

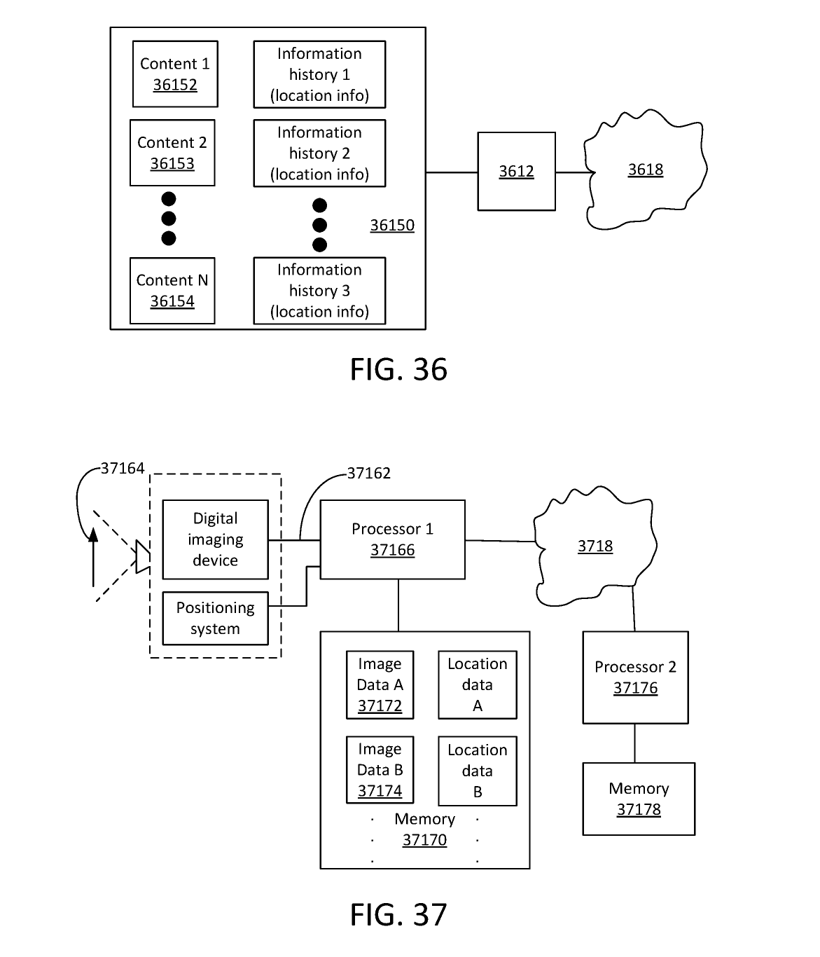

According to particular embodiments, aggregate site 2430 is monitored, randomly, periodically or continually, in order to ensure that performance provided on aggregate site 2430 meet the site's performance criterion (or criteria). Referring to FIGS. 25A-C, performers A1, A4, A6, B1 and B5 from performance sites 2520A, 2520B, respectively, are displayed on aggregate site 2530 at time T2+ (FIG. 25A). At time T3, a human observer (who can be, in various embodiments, the same observer who initially established aggregation links to the various compliant performances, or a different observer) observes that performer A1 now does not meet the aforementioned performance criterion, while performers A2 and A3 now meet the performance criterion. Thus, performers A2, A3, A4, A6, B1 and B5 meet the performance criterion at time T3. The human observer thus deletes the aggregation link to performer A1 from the window 2532 in aggregate site 2530, and replaces that aggregation link with an aggregation link to performer A2. The human observer also establishes an aggregation link to performer A3 and provides the aggregation fink to open window 2532 in aggregate site 2530 to provide an up-dated display on aggregate site 2530 at time T3+ (FIG. 25C). At subsequent times, as performers cease to meet the performance criterion, displays of their performances are removed from aggregate site 2530; likewise, as new performers meet the performance criterion, displays of their performances are added to aggregate site 2530 as window space permits.

Alternative procedures for ensuring the removal of performances that no longer comply with selected performance criteria are provided in further particular embodiments. According to certain embodiments, aggregation links are periodically or randomly disconnected. For example, in very specific embodiments, some or all aggregation links are subject to “automatic time-out” after a pre-determined time interval, such as 15 or 30 minutes, or alternatively, after a randomly determined time (which may include a minimum time, such as 10 minutes, and a randomly determined additional time). According to certain other embodiments, disconnection takes place when a previous video display is replaced (e.g., by a performer herself) with a display recognized as no longer meeting the performance criterion. Such displays include, for example, messages indicating that the performance is no longer accessible to viewers generally, such as “I'm in a private show now”. In some further embodiments, the data comprising a display such as one indicating “I'm in a private show now” is recognized by automated means. In still further embodiments the disconnection of the links and/or termination of the display on the aggregation site are effectuated by automated means. According to further embodiments, disconnection takes place when the displayed performance includes insufficient indications of compliance with performance criteria. For example, the displayed performance may no longer exhibit a sufficient display of skin tone to ensure that the performer is topless or nude. Such insufficiency can be recognized, in some specific embodiments, by a human observer as mentioned above, or alternatively, by feature recognition software.

Certain very specific embodiments of methods according to the invention employ bots to perform some or all of the functions of a human observer or observers, for example by sequentially evaluating performances and applying pattern-recognition software to determine, e.g., the extent of skin exposure, or satisfaction of other performance criteria such as presence of an audio stream, live video transmission, haptic data stream, etc.

Many of the foregoing embodiments employ one or more human observers, who are not the performers, or automated means to monitor one or more performance sites featuring a plurality of human performers and add, or delete, links to their performances or links to display links to their performances, to an aggregate site depending upon their compliance or non-compliance with one or more performance criteria. In some alternative embodiments, one or more performers on a performance site or sites may help to increase the viewership potential of their performances by providing notice to the aggregate site of the performer's compliance with the performance criterion or the performers intention or expectation that the performer will do so in the near future. In some particular embodiments, when a performer meets, or anticipates the performer will soon meet, a performance criterion (such as removal of some or all clothing) associated with a particular aggregate site, and desires to have his or her performance added to an aggregate site, the performer himself or herself provides notice to the aggregate site of his or her compliance with the performance criterion. In certain specific embodiments, the performer provides a signal to, or otherwise informs, the aggregate site indicating that compliance with the performance criterion is immediately imminent or currently in progress, and thus that she desires immediate addition of a display link to her performance to the aggregate site. In other specific embodiments, the performer provides notice to the aggregate site that compliance with the performance criterion will occur within a specified time interval or at one or more specified times. For example, the performer might provide notice to the aggregate site that she is one minute away from compliance with the performance criterion, at which point she desires that a display link to her performance be added to the aggregate site.

The performer can contact the aggregate site by any desired means, e.g., by activating a tab, button or other feature on an appropriate menu or other display provided by the aggregate site (or alternately a third party with which the aggregate site is affiliated) to the performer's computer via the network; or by alternative means such as personal communication with a human monitor providing aggregation links to the aggregate site as described above. For example, the performer may be provided with functionality on the performer's computer that enables the performer to click on a displayed a button icon (such as one that says “Add to Nude Now Website”, which when clicked by the performer sends a signal to the aggregation site instructing one or more aggregation site computers to establish a link to the performers performance computer and to add a display link to the aggregate site such that a user viewing the aggregate site on his or her computer would be provided with the means to click on the display link to access the performance of the performer. In some preferred embodiments, the signal from the performer to be added to the aggregation site is performed by an assistant or other third-party from the assistant or other third party's computer provided with such signaling functionality or by an automated means as described above where by the meeting of the performance criterion or criteria is detected by automated means. Once the aggregate site is notified of the compliance, the aggregate site (via, e.g., a human monitor, an application maintained by the aggregate site, or other desired means) establishes an aggregation link as described above, and provides the aggregation link to the aggregate site in order to afford access to the performer's performance in an available window or via a displayed link on the aggregate site.

According to further specific embodiments, a third party, such as a managing studio with which a performer is employed or otherwise affiliated, can contact the aggregate site as described above, i.e., to advise the aggregate site that the performer will comply with the performance criterion immediately or within an indicated time. The third party can thus, in various embodiments, contact the aggregate site as described above, such as by activating an appropriate tab, button or other feature on a display provided to the third party.

in additional particular embodiments, a performer provides to the aggregate site a premium (e.g., a monetary payment or any other exchange of value) in order to modify the position of the display of his or her performance, or indicia of his or her performance such as a thumbnail, etc., on the aggregate site vis-a-vis other performances or link to such performances. in very particular embodiments, the greater the value of the premium provided by the performer to the aggregate site, the more favorable the position, size or other beneficial attribute of the display of her performance on the aggregate site. Such favorable positions can include, for example, positions closer to a performance window 2432 in an enlarged first position (e.g., upper left) on a display on the aggregate site, or closer to a first page when the aggregate site provides multiple pages each presenting a plurality of performance windows 2432. In some preferred embodiments, the performer provides a premium to the providers of the aggregation website for the purpose of displaying advertising for the performer's upcoming performance(s) that meet the performance criteria or criterion, such as, for example when he or she will next be “nude now”.

In some embodiments, the operator of aggregate site provides the display of paid advertising in association with the display of live search results resulting from a user search using one or more specified search terms entered by a user of the aggregate site. In some embodiments the amount paid for such advertising by a third party is the highest amount bid for payment to the operator of the aggregate site among other advertisers bidding for the right to display advertising in association with displayed live performance site search results. In some embodiments the operator of the aggregator site can price the cost of publishing the advertising in association with the live site search results displayed based on the locations of the user devices on which such results are displayed. In some preferred embodiments the advertiser can specify the locations of the user computers on which such display advertising is to be displayed. For example, if the aggregate site operator charges more to an advertiser for display of the advertisers advertisement on user devices located throughout the world than on user devices located in the advertiser's home city, the advertiser may wish to have the aggregate site operator limit the publication of the advertisement associated with the search result to devices in the advertiser's home city. Limitation of transmission of such information based on the location of devices can be effectuated by any of the means set forth in U.S. patent application Ser. No. 09/812,296, incorporated herein by reference in its entirety as though set forth in full.

According to further embodiments of the present invention, a performer provides a premium to the aggregate site in order for her performance to be placed on the aggregate site upon compliance with a performance criterion. In more specific embodiments, the performer's performance is added to a plurality of aggregate sites at which the performer desires to appear upon compliance with appropriate performance criteria associated with such aggregate sites, either upon payment of a single fee or upon payment of a fee for each separate aggregate site.

Various of the foregoing embodiments aggregate performances obtained from and originally displayed on, or accessible via link from, on one or more sites that afford access to a plurality of performances, such as MyFreeCams.com®; Live Jasmine®, etc. Performances can also be aggregated from sites maintained, operated or utilized by individual performers, such as models, actresses (e.g.,“JaneDoe.com”), musicians, singers, etc. Combinations of the foregoing are also within the scope of the present invention. Thus, in some other embodiments of the invention, instead of providing a user with aggregated access to performances of performers that are “nude now” at an one or more aggregation sites, users may be provided with aggregated access to performances meeting one or more other criteria such as persons broadcasting their live travel now from their mobile cams, or persons providing live guitar lessons now, or persons providing live poker play now, etc.

Some of the foregoing embodiments employ one or more human observers to monitor one or more performance sites featuring a plurality of human performers and add, or delete, links to their performances to an aggregate site depending upon their compliance or non-compliance with one or more performance criteria. In an alternative embodiment, one or more performers on a performance site or sites desire to increase the viewership potential of their performances. In particular embodiments, when a performer meets, or anticipates meeting, a performance criterion (such as removal of some or all clothing) associated with a particular aggregate site, and desires to have her performance added to an aggregate site, the performer herself provides notice to the aggregate site of her compliance with the performance criterion. In certain specific embodiments, the performer provides a signal to, or otherwise informs, the aggregate site indicating that compliance with the performance criterion is immediately imminent or currently in progress, and thus that he or she desires immediate addition of his or her performance to the aggregate site. In other specific embodiments, the performer provides notice to the aggregate site that compliance with the performance criterion will occur within a specified time interval. For example, the performer might provide notice to the aggregate site that he or she is one minute away from compliance with the performance criterion, at which point she desires that her performance be added to the aggregate site.

The performer can contact the aggregate site to advise the aggregate site of the notice of compliance, or upcoming compliance, with the performance criterion by any desired means, e.g., by activating an application or other functionality via a tab, button or other feature on an appropriate menu or other display provided on the performer's computer or similar device. In some embodiments such functionality is provided to the performer's computer or other device by the aggregate site operator (or alternately a third party with which the aggregate site is affiliated) to the performer's computer or similar device via the network. In some embodiments, the aforesaid notice can be provided by the performer by alternative means such as personal communication with a human monitor providing aggregation links to the aggregate site as described above. Once the aggregate site is notified of the compliance (via, e.g., a human monitor, an application maintained by the aggregate site, or other desired means), the aggregate site establishes an aggregation link as described above, and provides the aggregation link to the aggregate site in order to afford user access to the performer's performance in an available window on the aggregate site.

According to further specific embodiments, a third party, such as a managing studio with which a performer is employed or otherwise affiliated, can contact the aggregate site as described above, to advise the aggregate site that the performer will comply with the performance criterion immediately or within an indicated time. The third party can thus, in various embodiments, contact the aggregate site as described above, such as by activating an appropriate tab, button or other feature on a display provided to the third party.

In additional particular embodiments, a performer provides to the aggregate site a premium (e.g., a monetary payment or any other exchange of value) in order to modify the position of the display of his or her performance, or indicia of his or her performance such as a thumbnail, etc., on the aggregate site vis-a-vis other performances or link to such performances. in some embodiments, the greater the value of the premium provided by the performer to the aggregate site, the more favorable the position, size or other beneficial attribute of the display of his or her performance on the aggregate site. Such favorable positions can include, for example, positions closer to a performance window 2532 in an enlarged first position (e.g., upper left) on a display on the aggregate site, or closer to a first page When the aggregate site provides multiple pages each presenting a plurality of performance windows 2532. In some preferred embodiments, the performer provides a premium to the providers of the aggregate website for the purpose of displaying advertising for the performer's upcoming performance(s) that meet the performance criteria or criterion, such as, for example when he or she will next be “nude now”, or when a. teacher will next be providing a particular lecture.

According to further embodiments of the present invention, a performer provides a premium to the aggregate site in order for her performance to be placed on the aggregate site upon compliance with a performance criterion. In more specific embodiments, the performer's performance is added to a plurality of aggregate sites at which the performer desires to appear upon compliance with appropriate performance criteria associated with such aggregate sites, either upon payment of a single fee or upon payment of a fee for each separate aggregate site.

Various of the foregoing embodiments aggregate performances obtained from and originally displayed on, or accessible via link from, on one or more sites that afford access to a. plurality of live performances, such as MyFreeCams.com®, Live Jasmine®, etc. Performances can also be aggregated from sites maintained, operated or utilized by individual performers, such as models, actresses (e.g., “JaneDoe.com”), musicians, singers, teachers, therapists, etc. It is to be understood that combinations of the foregoing are also within the scope of the present invention. Thus, in some other embodiments of the invention, instead of providing a user with aggregated access to performances of performers that are “nude now” at an one or more aggregation sites, users may be provided with aggregated access to performances meeting one or more other criteria. such as persons broadcasting their live travel experiences now from their mobile cams, or persons providing live guitar lessons now, persons providing live life coaching or live therapy now, or persons providing live poker play now, etc.

The foregoing embodiments of methods according to the invention make use of observers (e.g., humans or bots or other automated means) to determine compliance with performance criteria. Alternative methods according to the present invention afford direct linkage from a performer's performance site to an aggregate site. In such embodiments, the performer himself or herself establishes an aggregation link to the link associated with her performance when she determines that the performance meets or will meet the performance criterion, and then provides the aggregation link to an aggregate site. In more specific embodiments, the performer determines that the performance meets the performance criterion or will meet the performance criterion within a specified time interval, and then establishes the aggregation link as described.

Methods according to the invention can be used to aggregate and searchably display any type of live performance for which aggregation at an aggregate site is desired, and methods according to the invention may also be used employ any desired performance criterion or criteria. for displayed aggregation. Non-limiting exemplary types of performances include dances; dramatic performances (e.g., plays, readings of prose or poetical works.); musical performances (e.g., singing, playing musical instruments); consultations and other live services by professionals, such as legal professionals (e.g., attorneys, paralegals), financial professionals (e.g., accountants, tax preparers), medical professionals (e.g., doctors, nurses), therapists, life coaches, teachers, and lecturers, and gaming performances, such as live video gaming, gambling performances, such as poker play; and the like, such performances being made by single performers or groups of two or more performers. Non-limiting exemplary performance criteria include physical characteristics (e.g., eye color, hair color, hair length, race, ethnicity, age, sex, physical measurements such as height, weight and bust size, alone or in combination); performance type (e.g., playing guitar); professional specialization (e.g., corporate law, patent law, bankruptcy law, internal medicine, pediatric s); and performance activity, such as broadcasting travel via mobile phone cam, or remote shopping or travel assistance as described, for example, in U.S. Provisional Patent Application Ser. No. 61/626,343 filed Sep. 22, 2011 and U.S. Provisional Patent Application Ser. No. 61/626,787 filed Oct. 3, 2011 (the entire disclosures of each of the foregoing patent applications and patent are fully incorporated herein by reference as if fully set forth herein).

Further very specific embodiments of the inventive method are beneficially practiced when a performer's performance is subject to a regulation. Examples of such performances include, without limitation, those performances subject to the federal record-keeping requirements set forth in 18 U.S.C. §2257 18 U.S.C. §2257A etc., and related regulations set forth in 28 C.F.R. Part 75 et seq. (“2257 Regulations’). In some embodiments, compliance with the federal record-keeping requirement according to a method set forth in U.S. Pat. No. 8,027,929 is carried out prior to. or materially contemporaneously with, the production or transmission of a performance, or portion of a performance, that is subject to the federal record-keeping requirement, as described in the referenced patent.

For example, if the performer herself establishes an aggregation link to the aggregate site (i.e., self-populates the aggregation site), thus making her performance, or part thereof, visible on additional sites (such as one or more aggregate sites), she may be considered the distributor or producer of her performance as provided by §2257 Regulations with respect to the performance content make visible at such aggregate site(s). To comply with the §2257 Regulations, a producer of live performance content that is subject to the §2257 Regulations such as live performance content containing sexually explicit depictions) must affix or associate a compliance statement as specified by the §2257 with the subject content and the producer must update the producers records which are required to be maintained pursuant to the §2257 Records to reflect the creation and distribution of the subject performance content (e.g., by addition of the URL(s) of the aggregate site at which the live subject content is displayed, a unique identifier of the performance, date of production, copy of the depiction, etc., to the records maintained by the producer of the live performances subject to the §2257 Regulations). Thus, in some preferred embodiments. When the performer self-populates the aggregation site with an aggregation link to her performance, she also triggers the functionality of an automatic §2257 compliance system that updates a record system and provides an appropriate compliance statement that is displayed at the aggregation site(s), in accordance with the methods disclosed in U.S. Pat. No. 8,027,929.

Although the previous description only illustrates particular examples of various implementations, the invention is not limited to the foregoing illustrative examples. A person skilled in the art is aware that the invention as defined by the appended claims can be applied in various further implementations and modifications. In particular, a combination of the various features of the described implementations is possible, as far as these features are not in contradiction with each other. Accordingly, the foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

1. An system for selection of an agent, comprising:
a server with a network connection connected to a network
a location from an agent device that identifies the location of the agent received at the server via the network;
a request for an agent from a client device received at the server, where the server also identifies a client location and provides a list of possible agents to the client based partially on the location of the agent relative to the client location.

2. The system for selection of an agent of claim 1, includes a picture of one of the plurality of agents being sent by the server to the client.

3. The system for selection of an agent of claim 2, where the server receives at least one aspect used to generate the list of possible agents.
